(19) United States
(12) Patent Application Publication
(10) Pub. No.: US 2019/0153304 A1
(43) Pub. Date: May 23, 2019

(54) DRAG-REDUCING ADDITIVES HAVING DISPERSION POLYMERS AND MICROEMULSIONS AND METHODS FOR PREPARING AND USING SAME

(71) Applicant: Flotek Chemistry, LLC, Houston, TX (US)

(72) Inventor: Andrei Zelenev, Spring, TX (US)

(73) Assignee: Flotek Chemistry, LLC, Houston, TX (US)

(21) Appl. No.: 16/250,933

(22) Filed: Jan. 17, 2019

Related U.S. Application Data
(63) Continuation-in-part of application No. 16/206,907, filed on Nov. 30, 2018.
Application No. 16/206,907 is a continuation of application No. 15/907,226, filed on Feb. 27, 2018, now Pat. No. 10,144,865.
Application No. 15/907,226 is a division of application No. 14/323,830, filed on Jul. 3, 2014, now abandoned.
Application No. 14/323,830 is a continuation of application No. 12/268,408, filed on Nov. 10, 2008, now Pat. No. 8,865,632.

(51) Int. Cl. C09K 8/68; C09K 8/584; E21B 43/20; C09K 8/82; C09K 8/64; C09K 8/60; C09K 8/528; C09K 8/512; C09K 8/588

(52) U.S. Cl. CPC C09K 8/68; C09K 8/584; E21B 43/20; C09K 8/82; C09K 8/64; C09K 2208/28; C09K 8/528; C09K 8/512; C09K 8/588; C09K 8/608; C09K 8/604

(57) ABSTRACT

A drag-reducing additive comprises a dispersion polymer and a microemulsion. The dispersion polymer comprises a polymer and a saline solution, and the microemulsion comprises a solvent, a surfactant and an aqueous phase. The drag-reducing additive can be combined with an aqueous treatment fluid to form a drag-reducing composition. A method of using a drag-reducing composition, wherein the method comprises providing a drag-reducing additive comprising a dispersion polymer and microemulsion, forming the drag-reducing composition by combining the drag-reducing additive with an aqueous treatment fluid, and injecting the drag-reducing composition into a subterranean formation, a pipeline or a gathering line.

### RELATED APPLICATIONS

This application claims the benefit of and is a continuation-in-part of U.S. patent application Ser. No. 16/206,907 entitled “Method of Preparing and Using a Drag-Reducing Additive Having a Dispersion Polymer,” filed Nov. 30, 2018, which claims the benefit of and is continuation of U.S. patent application Ser. No. 15/907,226 entitled “Drag-Reducing Copolymer Compositions,” filed Feb. 27, 2018, which is now U.S. Pat. No. 10,144,865, which claims the benefit of and is a divisional of U.S. patent application Ser. No. 14/323,830 entitled “Drag-Reducing Copolymer Compositions,” filed Jul. 3, 2014, which is abandoned, which claims the benefit of and is a continuation of U.S. patent application Ser. No. 12/268,408, entitled “Drag-Reducing Copolymer Compositions,” filed Nov. 10, 2008, which is now U.S. Pat. No. 8,865,632, the disclosures of which are herein incorporated by reference.

### FIELD OF THE INVENTION

The present invention is generally related to the treatment of oil and gas wells and/or gathering lines and pipelines, and is more particularly related to a composition and process for reducing the drag or fluid friction caused by the injection of aqueous treatment fluids into subterranean geological formations, such as oil and gas wells.

### BACKGROUND OF THE INVENTION

Crude oil and natural gas are typically recovered from subterranean reservoirs through the use of drilled wells and production equipment. After the wells are drilled, cased and cemented, it is often necessary to stimulate the reservoir by means of hydraulic fracturing or acidizing to achieve economical flow of gas and oil. This typically requires pumping an aqueous treatment fluid into the well at high rates, so that the fluid will build up pressure and cause the formation to fracture.

In the process of pumping, substantial fluid friction or drag is observed between the treatment fluid and the tubing or casing as the fluid reaches turbulent flow, thus causing a substantial energy loss. As a result of the energy loss, a higher pumping pressure is needed to achieve the desired flow rate and pressure. It is therefore common to include drag-reducing additives in the aqueous treatment fluids to suppress the turbulence and realize lower pumping pressures. Common drag-reducing additives include oil-external emulsions of polymers with oil-based solvents and an emulsion-stabilizing surfactant. The emulsions may include guar-based or polyacrylamide-acrylic acid (PAM-AA) copolymers. Typically these prior art emulsions consist of an aqueous phase dispersed in a non-aqueous phase, in a weight ratio of from about 5:1 to about 10:1 aqueous phase to non-aqueous phase.

The types of surfactants in known drag reduction emulsions are typically emulsifying surfactants that stabilize the emulsions. The emulsifying surfactants have low hydrophile-lipophile balance (HLB) values, generally between about 4 and about 8. The transfer of the polymer from inside the aqueous phase of the oil-external emulsion into an aqueous treatment fluid is achieved by the inversion of an emulsion. A common way to achieve this inversion is to use an inverting surfactant, which is typically water-soluble and has an HLB of greater than about 7. Inverting surfactants may be a part of polymer emulsion formulations or may be added to a solution into which the emulsion is to be inverted.

The problem encountered with these known treatments, however, is that inverting surfactants may adversely interact with the emulsifier or emulsion and destroy it prior to use. Thus, commercially available polymer emulsions generally contain less than 5% of inverting surfactant. Polymer emulsions with this low amount of inverting surfactant, however, may not provide the desired reduction in friction because the polymer emulsion either does not invert completely or is not brine or acid tolerant.

In the event that acid or high salt contents are encountered, emulsion copolymers of 2-Acrylamido-2-methyl propane sulfonic acid (AMPS) are commonly used. These AMPS copolymers, however, may be cost prohibitive. In either case, the high molecular weight polymers may also cause substantial damage to the formation permeability. Thus, there is a continued need for more effective compounds that are more efficient, more salt tolerant, and less damaging.

### SUMMARY OF THE INVENTION

In one aspect, the present invention comprises a drag-reducing additive that comprises a dispersion polymer and a microemulsion. In exemplary embodiments, the dispersion polymer comprises a polymer and a saline solution and the microemulsion comprises a solvent, a surfactant and an aqueous phase.

In another aspect, the present invention comprises a drag-reducing composition that combines a drag-reducing additive with an aqueous treatment fluid. The drag-reducing additive comprises a dispersion polymer and a microemulsion. In exemplary embodiments, the dispersion polymer comprises a polymer and a saline solution and the microemulsion comprises a solvent, a surfactant and an aqueous phase. In yet another aspect, the present invention comprises a method of preparing a drag-reducing composition that comprises a dispersion polymer. In exemplary embodiments, the method comprises the step of preparing a dispersion polymer, which comprises the steps of preparing an aqueous mixture by adding a water-soluble salt and at least one polymeric dispersant to water, and polymerizing one or more water-soluble monomers in the aqueous mixture. The method optionally includes the steps of preparing a drag-reducing additive by mixing 40-85% by weight of the dispersion polymer with 10-35% by weight of a surfactant with an HLB greater than 8 and 5-30% by weight of a solvent, forming a drag-reducing composition by combining the drag-reducing additive with an aqueous treatment fluid; and injecting the drag-reducing composition into a subterranean formation, a pipeline or a gathering line.

In yet another aspect, the present invention comprises a method of using a drag-reducing compositing that comprises the steps of providing a drag-reducing additive comprising a dispersion polymer and a microemulsion; forming the drag-reducing composition by combining the drag-reducing additive with an aqueous treatment fluid; and injecting the drag-reducing composition into a subterranean formation, a pipeline or a gathering line.

### DRAWINGS

FIG. 1 is a graph displaying the results of friction reduction tests conducted on various formulations of the present invention compared against an anionic control dispersion polymer.

FIG. 2 is a graph displaying the results of friction reduction tests conducted on various formulations of the present invention compared against a control amphoteric dispersion polymer.

FIG. 3 is a graph displaying the results of friction reduction tests conducted on various formulations of the present invention compared against a cationic control dispersion polymer.

FIG. 4 is a graph displaying the results of friction reduction tests conducted on various formulations of the present invention compared against an amphoteric control dispersion polymer.

FIG. 5 is a graph displaying the results of friction reduction tests conducted on various formulations of the present invention compared against an anionic control dispersion polymer.

FIG. 6 is a graph displaying the results of friction reduction tests conducted on various formulations of the present invention compared against a cationic control dispersion polymer.

FIG. 7 is a photograph showing a series of compositions comprising various combinations of anionic dispersion polymer, solvent, surfactant, and/or microemulsion formulations of the present invention immediately after initial mixing.

FIG. 8 is a photograph showing the compositions of FIG. 7 that have been turned upside down, after one hour had elapsed after initial mixing.

### DETAILED DESCRIPTION OF PREFERRED EMBODIMENTS

The present invention relates to the preparation and use of a polymer composition that can be used as a drag-reducing additive. Unlike prior art drag reducers, the additives of the preferred embodiments are formed by the combination of polymer with relatively high amount of surfactant. In other preferred embodiments, the drag-reducing additives are formed by a combination of polymer with a relatively low amounts of solvent and/or surfactant. In one embodiment, a three-component additive is formed upon the combination of a polymer and a surfactant with a solvent. In an alternate embodiment, a two-component additive is formed upon a combination of a polymer and a surfactant. It is understood that the compositions of these embodiments have a variety of uses, one of which is drag reduction. The solvent is preferably a terpene. The additives can be added to an appropriate treatment fluid to form a well treatment composition or a composition for treatment of gathering lines or pipelines.

In a preferred embodiment, the polymer component of the additive is in the form of a commercially-available polymer emulsion, which typically already includes some solvent and emulsion surfactant. However, polymer emulsion could be synthesized, instead of purchased. It will be understood that the term “polymer” includes both homopolymers and copolymers. Upon addition to the treatment fluid, the components of the drag-reducing additive form an oil-in-water emulsion that reduces the friction between the turbulent flow of the treatment fluid and the walls of the well tubing or casing, or the walls of a pipeline or gathering line. In a preferred embodiment, the treatment fluid is water-based. Upon dilution, the additive may form a microemulsion, a miniemulsion, a nanoemulsion or an emulsion.

By adding a relatively large amount of surfactant to the additive, compared to surfactant levels in prior art friction reducers, the hydrophilicity and dispersibility of the polymer is increased, thus increasing the stability of the system in aqueous downhole fluid or in a pipeline or gathering lines. Furthermore, the increased surfactant level increases the inversion rate of the additive, even under low energy conditions. As a result, less polymer is needed to achieve the desired friction-reducing performance, which results in less damage downhole. Another benefit of the increased surfactant level in the additive is improved performance in brine.

The first component in the system, the polymer, may be nonionic, zwitterionic, amphoteric, anionic, or cationic. The polymer may further be a dispersion polymer or an emulsion polymer, which may be nonionic, zwitterionic, amphoteric, anionic, or cationic. Such polymer preferably consists of acrylamide present in the amount between 1 and 100 mole % and cationic, anionic, zwitterionic, amphoteric, or nonionic monomers present in the amount between 0 and 99 mole %.

When the copolymer includes acrylamide and an anionic monomer, the anionic monomer may be acrylamidopropanesulfonic acid, acrylic acid, methacrylic acid, monoacryloxyethyl phosphate, or their alkali metal salts. When the copolymer includes acrylamide and a cationic monomer, the cationic monomer may be dimethylaminoethylacrylate methyl chloride quarternary salt, diallyldimethylammonium chloride (DADMAC), (3-acrylamidopropyl)trimethylammonium chloride (MAPTAC), (3-methacrylamido)propyltrimethylammonium chloride, dimethylaminoethyl-methacrylate methyl chloride quarternary salt, or dimethylaminoethylacrylate benzylchloride quarternary salt.

When the copolymer includes acrylamide and a nonionic monomer, the nonionic monomer may be acrylamide, methacrylamide, N-methylacrylamide, N,N-dimethyl(meth)acrylamide, octyl acrylamide, N(2-hydroxypropyl)methacrylamide, N-methylolacrylamide, N-vinylformamide, N-vinylacetamide, N-vinyl-N-methylacetamide, poly(ethylene glycol)(meth)acrylate, poly(ethylene glycol) monomethyl ether mono(meth)acrylate, N-vinyl-2-pyrrolidone, glycerol mono((meth)acrylate, 2-hydroxyethyl (meth)acrylate, vinyl methylsulfone, or vinyl acetate.

When the copolymer includes acrylamide and a zwitterionic monomer, the zwitterionic monomer may be selected from those described in U.S. Pat. No. 6,709,551 or be selected from N,N-dimethyl-N-acryloyloxyethynyl-N-(3-sulfopropyl)-ammonium betaine, N,N-dimethyl-N-acrylamidopropyl-N-(2-carboxymethyl)-ammonium betaine, N,N-dimethyl-N-methacrylcryloyloxyethynyl-N-(3-sulfopropyl)-ammonium betaine, N,N-dimethyl-N-methacrylcryloyloxyethynyl-N-(3-sulfopropyl)-sulfoneum betaine, 2-(methylthio)ethyl methacryloyl-S-(sulfopropyl)-sulfonium betaine, 2-[(2-acryloylethyl)dimethylammonio]ethyl 2-methyl phosphate, 2-(acryloyloxyethyl)-2′-(trimethylammonium)ethyl phosphate, or [(2-acryloylethyl)dimethylammonio]methyl phosphonic acid. It will be understood that the lists of potential monomers are not limiting, and the use of other monomers may also be appropriate.

From testing of various polymers in the three-component additive embodiment, it was determined that the use of a copolymer made up of polyacrylamide and an anionic monomer additive resulted in increased permeability restoration when compared to copolymers with nonionic or cationic monomers. Thus, it is preferred to use a copolymer of acrylamide and an anionic monomer, such as acrylic acid. In a presently preferred embodiment, the copolymer is a polyacrylamide-acrylic acid (PAM-AA) copolymer having a molecular weight from about 4 million to 20 million amu (atomic mass unit), with a percentage of acrylamide in the range of 60-99% by weight and a percentage of acrylic acid from 1 to 40% by weight.

The second component in the three component additive embodiment, the surfactant, may have a hydrophile-lipophile balance (HLB) of above about 7, and preferably has an HLB of between about 11 and about 15. It will be understood that the surfactant component may be made up of one surfactant or a blend of surfactants. Highly preferred nonionic surfactants have an HLB of about 12 to about 13. These surfactants aid in the inversion of the polymer when the additive comes into contact with aqueous treatment fluid, and are sometimes referred to as inverting surfactants. Preferred surfactants are liquids chosen from ethoxylated glycerides, ethoxylated sorbitan esters, ethoxylated alkyl phenols, ethoxylated alcohols, castor oil ethoxylates, cocoamide ethoxylates, and sorbitan monooleates such as polyoxyethylene 20 sorbitan monooleate (Tween® 80). In a particularly preferred embodiment, the surfactant is a castor oil ethoxylate with 30 moles of ethylene oxide (EO) per 1 mole of castor oil ethoxylate. In an alternate particularity preferred embodiment, the surfactant component is a surfactant mixture of: (i) alcohol ethoxylate C₈-C₁₈ with 5-20 moles EO; and (ii) ethoxylated castor oil with 25-45 moles of EO.

The third component in the three-component additive embodiment, the solvent, is preferably a blend of naturally occurring plant terpenes. Terpenes often consist of units of isoprene and have the formula (C₅H₈)ₙ, where n is the number of linked isoprene units. Other terpenes, such as those found in eucalyptus and peppermint oils, may include compounds containing oxygen. A complex plant-derived terpene typically includes a variety of compounds, including monoterpenes (C₁₀H₁₆), d-limonene, dipentene, l-limonene, d,l-limonene, myrcene, and α-pinene. Additional terpenes include terpinolene, β-pinene, eucalyptol, α-terpineol, β-terpineol, sabinene, menthofurane, 1,8-cineole, citronellal, cintronellol, menthol, mentohone, and alcohols and aldehydes of the same composition and mixtures thereof.

The terpene blend may be further combined with other solvents such as other plant-derived alcohols or esters, or aromatic hydrocarbons. Plant-derived alcohols in the solvent may include terpenoids and straight chain alcohols with the formula CH₃(CH₂)ₙOH, where n≥9 or 11. Plant-derived esters include methyl and ethyl esters of naturally-occurring oils such as cottonseed or soybean oil. It should be noted that synthetic solvents can also be used as the solvent phase.

In a preferred embodiment, the solvent has a KB (Kauri-butanol) value of greater than about 60. Preferred terpenes are those derived from citrus fruits, eucalyptus, or mint. In a particularly preferred embodiment, the solvent is a biodegradable solvent blend primarily made up of d-limonene.

Emulsion polymers that comprise a component of the present additive can be either obtained from commercial suppliers or be synthesized. In a preferred embodiment, a drag-reducing additive is made by mixing about 40 to 85% by weight of a commercially available polymer emulsion, such as the type available from Hychem, Inc., with about 5 to 30% by weight additional solvent and about 5 to 35% by weight of additional surfactant. The commercially available polymer emulsion may include a polymer and small amounts of an emulsion surfactant, a solvent, and possibly an inverting surfactant. Thus, the additional solvent that is added to the polymer emulsion will be referred to as the second solvent, and the additional surfactant that is added to the polymer emulsion will be referred to as the second surfactant.

In a particularly preferred embodiment, the three-component drag-reducing additive is prepared by blending about 55 to 65% by weight of a commercially available polymer emulsion with about 10 to 30% by weight of a second terpene solvent and about 20% to 35% by weight of a second nonionic surfactant. In this preferred embodiment, the second nonionic surfactant is made up primarily of a surfactant with an HLB of about 12 to about 13, such as a castor oil ethoxylate with 30 moles of ethylene oxide. The commercially available polymer emulsion preferably includes acrylamide in the range of 60 to 90% by weight and acrylic acid in the range of 5 to 30% by weight. It is preferred to mix the additional surfactant and solvent before adding the polymer emulsion, but order of mixing is not critical. In other preferred embodiments, the drag-reducing additive includes other additives such as acids, bases, corrosion inhibitors, proppants, biocides, oxygen scavengers, asphaltene inhibitors, demulsifiers, freezing point depression agents, scale inhibitor, corrosion inhibitor, buffers, viscosifiers, clay control inhibitors, breakers, paraffin control additives, salts, and oils.

In another embodiment, three-component drag-reducing additive is formed by synthesizing a polymer emulsion that is combined with the second terpene solvent and second surfactant, instead of using a commercially available polymer emulsion. The synthesized polymer emulsion is combined with the second solvent and second surfactant in the amounts described above. Methods suitable for preparation of emulsion polymers are well known to those skilled in the art. For example, such methods are described in U.S. Pat. Nos. 3,284,393; 3,734,873; 6,605,674; and 6,753,388. Suitable emulsion polymers can be prepared by a process that typically involves preparing an oil phase containing suitable surfactants, preparing an aqueous monomer phase containing the monomers, preparing a water-in-oil emulsion of the aqueous phase in the oil phase, and performing polymerization of monomers, usually by means of free radical polymerization. In certain instances structural modifiers or crosslinking agents can be added at various stages of the process. Suitable such agents and means of their addition would be known to those skilled in the art. Polymer solids in the prepared emulsion polymers typically comprise from about 5 to about 60% by weight. It should be understood, however, that there may be other methods of preparing the suitable polymer emulsion.

Friction reducing polymers suitable to practice the present invention may also be chosen from a class of dispersion polymers, such as those described in U.S. Pat. Nos. 4,929,655; 5,605,970; 5,837,776; 5,597,858; 6,217,778; 6,365,052; 7,323,510; and European patent EP 630,909, each of which is incorporated herein by reference in its entirety and for all purposes. Use of dispersion polymers for reducing friction has been disclosed in U.S. Pat. No. 6,787,506, which is incorporated herein by reference in its entirety and for all purposes. Dispersion polymers may either be acquired from a commercial source or synthesized. Typical synthesis of dispersion polymers involves polymerizing one or more water-soluble monomers in an aqueous reaction mixture, wherein the aqueous reaction mixture contains a water soluble salt, at least one polymeric dispersant, optionally contains an organic alcohol, optionally contains a pre-formed polymer seed. The water soluble polymer formed as a result of polymerization is insoluble in the aqueous reaction mixture at the concentration thereof formed during the polymerization. Polymer solids in the prepared dispersion are typically from about 5% to about 60% by weight.

Dispersion polymers were developed in an effort to bring to market more environmentally-friendly polymer formulations. Commercially-available dispersion polymers typically do not contain surfactants, solvents, or microemulsions. The dispersion polymer is typically limited to the selected polymer and an aqueous saline solution. The dispersion polymer technology is very different from emulsion polymer technology because there is no water-insoluble oil or emulsifying or inverting surfactants involved in making dispersion polymers. Therefore, the term “inversion” commonly associated with emulsion polymers does not have any technical meaning in relationship to dispersion polymers. The polymer coil of a dispersion polymer is released from its compact state in which it is present in the saline solution upon dilution with water while applying shear stress, such as for example, in mixing.

Dispersion polymers are environmentally friendly, because they do not contain surfactants, solvents, microemulsions, or combinations thereof. As such, dispersion polymers do not contain volatile organic compounds (VOCs), and therefore, are safer to transport and easier to comply with environmental regulations. Drag-reducing additives comprising dispersion polymers, solvents, surfactants, microemulsions, or combinations thereof, may provide the benefit of reducing friction as attributed by the dispersion polymer, but also may simultaneously decrease the degree of formation damage, improve well clean-up, provide the benefit of lowering capillary pressure, and dissolve unwanted deposits as attributed by the solvents, surfactants, microemulsions or combinations therefore. These benefits will results in an improvement of rates of oil and gas production. For those reasons, it is desirable to develop drag-reducing additives comprising dispersion polymers that further comprise solvents, surfactants, microemulsions, or combinations thereof, for the purpose of improving overall well productivity performance, while still maintaining friction reduction performance.

The ability to include solvents, surfactants, microemulsions, or combinations thereof to a dispersion polymer on a selective basis also gives the flexibility to pump or inject compositions that would have satisfactory environmental performance, satisfactory friction reduction, while simultaneously delivering the benefits associated with the use of solvents, surfactants, microemulsions, and combinations thereof. Blending of dispersion polymers with additives (e.g. solvents, surfactants, microemulsions, or combinations thereof) can be carried out either in a blending facility or at the well site. A person skilled in the art would know the specific conditions and equipment necessary to manufacture the drag-reducing additives of the present invention.

Emulsions and Microemulsions

It should be understand that while many of the embodiments described herein refer to microemulsions, this is by no means limiting, and emulsions may also be encompassed, where appropriate.

The terms emulsions and microemulsions should be understood to include emulsions or microemulsions that have a water continuous phase, or that have an oil continuous phase, or microemulsions that are bicontinuous or multiple continuous phases of water and oil. In some embodiments, the emulsion or microemulsion has a water continuous phase.

The term emulsion is given its ordinary meaning in the art and refers to dispersions of one immiscible liquid in another, in the form of droplets, with diameters approximately in the range of 100-1,000 nanometers. In some embodiments, emulsions may be thermodynamically unstable and/or require high shear forces to induce their formation. Emulsions may have an enhanced kinetic stability and be resistant towards separating into individual phases over very long periods of time such as days, weeks, months or even years.

The term microemulsion is given its ordinary meaning in the art and refers to dispersions of one immiscible liquid in another, in the form of droplets, with diameters approximately in the range of about from about 1 nanometers (nm) to about 1000 nm, or from about 10 nm to about 1000 nm, or from about 10 nm to about 500 nm, or from about 10 nm to about 300 nm, or from about 10 nm to about 100 nm.

Microemulsions are homogeneous thermodynamically stable single phases, and form spontaneously, and thus, differ markedly from thermodynamically unstable emulsions, which generally depend upon intense mixing energy for their formation. Microemulsions may be characterized by a variety of advantageous properties including, by not limited to, (i) clarity, (ii) very small particle size, (iii) ultra-low interfacial tensions, (iv) the ability to combine properties of water and oil in a single homogeneous fluid, (v) shelf life stability, and (vi) ease of preparation.

In some embodiments, the microemulsions described herein are stabilized microemulsions that are formed by the combination of a solvent-surfactant blend with an appropriate oil-based or water-based carrier fluid. Generally, the microemulsion forms upon simple mixing of the components without the need for high shearing generally required in the formation of ordinary emulsions. In some embodiments, the microemulsion is a thermodynamically stable system, and the droplets remain finely dispersed over time. In some embodiments, the average droplet size ranges from about 10 nm to about 300 nm.

In some embodiments microemulsions are balanced, or bicontinuous. In bicontinuous microemulsions, the dispersed phase is not present in the form of distinct droplets characterized by a droplet size distribution, but rather forms a structure consisting of interpenetrating channels of dispersed phase and continuous phase.

Further, a microemulsion may also refer to a thermodynamically stable dispersion of water and oil that forms spontaneously upon mixture of oil, water and various surfactants. Microemulsion droplets generally have a mean diameter of less than 300 nm. Because microemulsion droplets are smaller than the wavelength of visible light, solutions comprising them are generally translucent or transparent, unless there are other components present that interfere with passage of visible light. In some embodiments, a microemulsion is substantially homogeneous. In other embodiments, microemulsion particles may co-exist with other surfactant-mediated systems, e.g., micelles, hydrosols, and/or macroemulsions. In some embodiments, the microemulsions of the present invention are oil-in-water microemulsions. In some embodiments, the majority of the oil component, e.g., (in various embodiments, greater than about 50%, greater than about 75%, or greater than about 90%), is located in microemulsion droplets rather than in micelles or macroemulsion droplets. In various embodiments, the microemulsions of the invention are clear or substantially clear.

The conventional terms water-in-oil and oil-in-water, whether referring to macroemulsions, emulsions, or microemulsions, simply describe systems that are water-discontinuous and water-continuous, respectively. They do not denote any additional restrictions on the range of substances denoted as “oil”.

The terms clear or transparent as applied to a microemulsion are given its ordinary meaning in the art and generally refers to the microemulsion appearing as a single phase without any particulate or colloidal material or a second phase being present when viewed by the naked eye.

In some embodiments, the emulsions or microemulsions described herein are stable over a wide range of temperatures. In some embodiments, the emulsion or microemulsion is stable at temperatures greater than about −25° C., or greater than about −20° C., or greater than about −15° C., or greater than about −10° C., or greater than about −5° C., or greater than about 0° C. In some embodiments, the emulsion or microemulsion is stable at temperatures up to about 25° C., or up to about 30° C., or up to about 40° C., or up to about 50° C., or up to about 55° C., or up to about 60° C., or up to about 70° C. Combinations of these above mentioned ranges are possible, for example, the microemulsion is stable for temperatures between about −10° C. and about 55° C. Those of ordinary skill in the art will be aware of methods for determining the stability of an emulsion or microemulsion over a range of temperatures, for example mixing a sample of surfactant, solvent, and water in a container (e.g., having a volume between 10 and 50 milliliters), applying a low amount of shear (e.g., by hand with a gentle rocking motion back and forth), and placing the sealed glass jar at a fixed temperature (e.g., in a cold bath or oven at a fixed temperature depending upon whether low temperature or high temperature stability are preferentially investigated, respectively). Samples can be observed over time (e.g., once an hour) to determine visually if the microemulsion is becoming destabilized, for example, as indicated by the formation of a hazy coacervate, precipitate, or flocculation within the sample jar.

Without wishing to be bound by theory, the emulsions and microemulsions described herein may provide a combination of desired features for use in oil and/or gas well application. For example, the presence of one or more long chain hydrocarbon solvents may provide a solvency that is not observed when using shorter chain hydrocarbon solvents. Furthermore, the emulsions or microemulsions described herein may provide an increased surface activity as compared to similar emulsions or microemulsions not including the described combination of solvents.

Solvents

In some embodiments, the microemulsion comprises at least two types of solvents (e.g., a first type of solvent and a second type of solvent). In some embodiments, the first type of solvent is a long chain hydrocarbon solvent. In some embodiments, the second type of solvent is an oxygenated solvent. Without wishing to be bound by theory, the ratio of the first type of solvent to the second type of solvent may affect the ability to form a stable emulsion or microemulsion with the selected solvents. For example, in embodiments wherein only the first type of solvent or only the second type of solvent is present in a composition, a stable emulsion or microemulsion may not form, whereas a stable emulsion or microemulsion can form under essentially the same conditions (e.g., temperature, pressure) wherein both the first type of solvent and the second type of solvent are present in a selected ratio (e.g., at the same total weight percent). In some embodiments, the first type of solvent (e.g., long chain hydrocarbon solvent) and the second type of solvent (e.g., oxygenated solvent) may be provided in a ratio between about 11:4 to about 1:1, or between about 5:1 to about 1:5, or between about 4:1 to about 1:1, or between about 6:1 to about 1:1, by weight of the first type of solvent to the second type of solvent.

The emulsion or microemulsion generally comprises a non-aqueous phase. In some embodiments, the non-aqueous phase comprises a solvent or a solvent blend, comprising at least two types of solvents. For example, the solvent blend may comprise a first type of solvent and a second type of solvent. As described herein, in some embodiments, the first type of solvent is a long chain hydrocarbon solvent and/or the second type of solvent is an oxygenated solvent.

In some embodiments, the emulsion or microemulsion comprises from about 1 wt % to about 30 wt %, or from about 2 wt % to about 25 wt %, or from about 5 wt % to about 25 wt %, or from about 15 wt % to about 25 wt %, or from about 3 wt % to about 40 wt %, or from about 5 wt % to about 30 wt %, or from about 7 wt % to about 22 wt % of the total amount of the one or more types of solvent, versus the total weight of the emulsion or microemulsion composition.

In some embodiments, each solvent type may comprise more than one solvent of that type. For example, the first type of solvent may include a single long chain hydrocarbon solvent or a plurality of types of long chain hydrocarbon solvents. As another non-limiting example, the second type of solvent may include a single oxygenated solvent or a plurality of types of oxygenated solvents. In some embodiments, a solvent is a liquid that dissolves other substances, for example, residues or other substances found at or in a wellbore (e.g. kerogens, asphaltenes, paraffins, organic scale).

Long-Chain Hydrocarbon Solvents

In some embodiments, the first type of solvent is a long chain hydrocarbon solvent or comprises a plurality of types of long chain hydrocarbon solvents. The term hydrocarbon solvent encompasses unsubstituted cyclic or acyclic, branched or unbranched, saturated or unsaturated, hydrocarbon compounds (e.g., alkanes, alkenes) The term long chain encompasses solvent having a high number of carbon atoms, for example, 12-22, or 12-20, or 12-18, or 14-24, or 14-22, or 14-20, or 13-23, or 11-14, carbon atoms, inclusive.

In some embodiments, the first type of solvent is or comprises a mixture of C₁₂₋₂₂ hydrocarbon solvents, or a mixture of C₁₂₋₂₀ hydrocarbon solvents, or a mixture of C₁₂₋₁₈ hydrocarbon solvents, or a mixture of C₁₄₋₂₄ hydrocarbon solvents, or a mixture of C₁₄₋₂₂ hydrocarbon solvents, or a mixture of C₁₄₋₂₀ hydrocarbon solvents, or a mixture of C₁₃₋₂₃ hydrocarbon solvents, or a mixture of C₁₁₋₁₄ hydrocarbon solvents. In some embodiments, the hydrocarbon solvents are unsubstituted cyclic or acyclic, branched or unbranched alkanes. In some embodiments, the hydrocarbon solvents are unsubstituted cyclic or acyclic, branched or unbranched alkenes. In some embodiments, the hydrocarbon solvents include a combination of unsubstituted cyclic or acyclic, branched or unbranched alkanes and unsubstituted cyclic or acyclic, branched or unbranched alkenes.

In some embodiments, the first type of solvent is an aliphatic mineral spirit, which is given its ordinary meaning in the art and refers to a solvent comprising a plurality of types of long chain hydrocarbon solvents, generally alkanes. The aliphatic mineral spirit may be purchased from a commercial source. Non-limiting examples of aliphatic mineral spirits that may be purchased include EFC Crystal 210 solvent (available from Total), Shellsol D80 (available from Shell®), and Exxsol™ D80 (available from Exxon Mobil®). In some embodiments, the aliphatic mineral spirit has a high boiling point (e.g., greater than about 150° C., or greater than about 180° C., or greater than about 200° C.) and/or a low vapor pressure (e.g., less than about 1 kPa). As will be known to those of ordinary skill in the art, aliphatic mineral spirits may comprise a small amount of impurities (e.g., aromatic compounds) due to the manner in which they are prepared (e.g., hydrogenation of petroleum fractions). In some embodiments, the aliphatic mineral spirit comprises less than about 2%, or less than about 1%, or less than about 0.5%, or less than about 0.1%, or less than about 0.05%, impurities (e.g., aromatic compounds).

In some embodiments, the first type of solvent is a long chain alpha-olefin solvent or comprises a mixture of long chain alpha-olefin solvents. Alpha-olefins (or α-olefins) are a family of organic compounds which are alkenes (also known as olefins) with a chemical formula CₓH₂ₓ, distinguished by having a double bond at the primary or alpha (a) position. In some embodiments, x is 12-22, or 12-20, or 12-18, or 14-24, or 14-22, or 14-20, or 13-23, or 11-14. In some embodiments, the first type of solvent is a C₁₂₋₁₈ alpha-olefin solvent or comprises more than one type of C₁₂₋₁₈ alpha-olefin solvents. Non-limiting examples of C₁₂₋₁₈ alpha-olefin solvents include 1-dodecene, 2-methyl-1-undecene, 1-tridecene, 2-methyl-1-dodecene, 1-tetradecene, 2-methyl-1-tridecene, 1-pentadecene, 2-methyl-1-tetradecene, 1-hexadecene, 2-methyl-1-pentadecene, 1-heptadecene, 2-methyl-1-hexadecene, 1-octadecene, and 2-methyl-1-heptadecene.

In some embodiments, the first type of solvent (e.g., long chain hydrocarbon solvent) is present in an amount from about 1 wt % to about 25 wt %, or about 1 wt % to about 20 wt %, or from about 1 wt % to about 15 wt %, or from about 1 wt % to about 10 wt %, or from about 1 wt % and about 5 wt %, or from about 1 wt % and about 3 wt %, versus the total microemulsion.

Oxygenated Solvents

In some embodiments, the second type of solvent comprises an oxygenated solvent. As used herein, the term oxygenated solvent is given its ordinary meaning in the art and refers to solvents comprising one or more oxygen atoms in their molecular structure in addition to carbon atoms and hydrogen (e.g., an oxygenated hydrocarbon solvent). For example, the solvent may comprise one or more of an alcohol, an aldehyde, a ketone, an ester, or an ether. In some embodiments, the oxygenated solvent comprises a plurality of types of oxygenated solvents having 6-22 carbon atoms, or 6-18 carbon atoms, or 8-18 carbon atoms, or 12-18 carbon atoms. Non-limiting examples of oxygenated solvents include oxygenated terpenes, alcohols, ketones, aldehydes, and esters.

In some embodiments, the ketone is a ketone having 12-18 carbon atoms. In some embodiments, the aldehyde is an aldehyde having 12-18 carbon atoms. In some embodiments, the ester is an ester having 6-22 carbon atoms. In some embodiments, the ester is a methyl ester having 6-22 carbon atoms. In some embodiments, the ester is an alkyl aliphatic carboxylic acid ester.

In some embodiments, the second type of solvent is an alcohol. For example, the alcohol may be a cyclic or acyclic, branched or unbranched alkane having 6 to 12 carbon atoms and substituted with a hydroxyl group (e.g., an alcohol). Non-limiting examples of cyclic or acyclic, branched or unbranched alkanes having 6 to 12 carbon atoms and substituted with a hydroxyl group include isomers of heptanol, isomers of octanol, isomers of nonanol, isomers of decanol, isomers of undecanol, isomers of dodecanol, and combinations thereof.

Non-limiting examples of alcohols include isomers of octanol (e.g., 1-octanol, 2-octanol, 3-octanol, 4-octanol), isomers of methyl heptanol, isomers of ethylhexanol (e.g., 2-ethyl-1-hexanol, 3-ethyl-1-hexanol, 4-ethyl-1-hexanol), isomers of dimethylhexanol, isomers of propylpentanol, isomers of methylethylpentanol, isomers of trimethylpentanol, and combinations thereof. In a particular embodiment, the cyclic or acyclic, branched or unbranched alkane has 8 carbon atoms and is substituted with a hydroxyl group. In a particular embodiment, the oxygenated solvent is isooctanol.

Non-limiting examples of oxygenated terpenes include terpenes containing alcohol, aldehyde, ether, or ketone groups. In some embodiments, the terpene comprises an ether-oxygen, for example, eucalyptol, or a carbonyl oxygen, for example, menthone. In some embodiments, the terpene is a terpene alcohol. Non-limiting examples of terpene alcohols include linalool, geraniol, nopol, α-terpineol, and menthol. Non-limiting examples of oxygenated terpenes include eucalyptol, 1,8-cineol, menthone, and carvone.

As used herein, “alkyl aliphatic carboxylic acid ester” refers to a compound or a blend of compounds having the general formula:

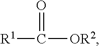

wherein R¹ is an optionally substituted aliphatic group, including those bearing heteroatom-containing substituent groups, and R² is a C₁ to C₆ alkyl group. In some embodiments, R¹ is C₆ to C₂₂ alkyl. In some embodiments, R¹ is substituted with at least one heteroatom-containing substituent group. For example, wherein a blend of compounds is provided and each R² is —CH₃ and each R¹ is independently a C₆ to C₂₂ aliphatic group, the blend of compounds is referred to as methyl aliphatic carboxylic acid esters, or methyl esters. In some embodiments, such alkyl aliphatic carboxylic acid esters may be derived from a fully synthetic process or from natural products, and thus comprise a blend of more than one ester. In some embodiments, the alkyl aliphatic carboxylic acid ester comprises butyl 3-hydroxybutyrate, isopropyl 3-hydroxybutyrate, hexyl 3-hydroxylbutyrate, and combinations thereof. Non-limiting examples of alkyl aliphatic carboxylic acid esters include methyl octanoate, methyl decanoate, a blend of methyl octanoate and methyl decanoate, methyl octenoate, methyl decenoate, methyl dodecenoate, methyl tetradodecenoate, and butyl 3-hydroxybutyrate.

In some embodiments, the emulsion or microemulsion may comprise a branched or unbranched dialkylether having the formula C—H₂ₙ₊₁OCₘH₂ₘ₊₁ wherein n+m is from 6 to 16. In some embodiments, n+m is from 6 to 12, or from 6 to 10, or from 6 to 8. Non-limiting examples of branched or unbranched dialkylether compounds having the formula CₙH₂ₙ₊₁OCₘH₂ₘ₊₁ include isomers of C₃H₇OC₃H₇, isomers of C₄H₉OC₃H₇, isomers of C₅H₁₁OC₃H₇, isomers of C₆H₁₃OC₃H₇, isomers of C₄H₉OC₄H₉, isomers of C₄H₉OC₅H₁₁, isomers of C₄H₉OC₆H₁₃, isomers of C₅H₁₁OC₆H₁₃, and isomers of C₆H₁₃OC₆H₁₃. In a particular embodiment, the branched or unbranched dialklyether is an isomer of C₆H₁₃OC₆H₁₃ (e.g., dihexylether).

Other non-limiting examples of oxygenated solvents include 2-(acetoacetoxy)ethyl methacrylate, 2-(hydroxyethyl) methacrylate, 2,2-dimethyl-1,3-propanediol, 1,4-cyclohexanedimethanol, and oxoacids having 3-8 carbon atoms.

In some embodiments, the second type of solvent is present in an amount from about 0.5 wt % to about 25 wt %, or from about 1 wt % to about 20 wt %, or from about 1 wt % to about 15 wt %, or from about 1 wt % to about 10 wt %, or from about 1 wt % and about 5 wt %, or from about 1 wt % and about 3 wt %, versus the total microemulsion.

Other Types of Solvents

In some embodiments, the emulsion or microemulsion may comprise additional types of solvents. Non-limiting examples of such solvents include terpenes, terpineols, terpene alcohols, aldehydes, ketones, esters, amines, and amides.

Terpenes are generally derived biosynthetically from units of isoprene. Terpenes may be generally classified as monoterpenes (e.g., having two isoprene units), sesquiterpenes (e.g., having 3 isoprene units), diterpenes, or the like. The term “terpenoid” includes natural degradation products, such as ionones, and natural and synthetic derivatives, e.g., terpene alcohols, ethers, aldehydes, ketones, acids, esters, epoxides, and hydrogenation products (e.g., see Ullmann's Encyclopedia of Industrial Chemistry, 2012, pages 29-45, herein incorporated by reference). In some embodiments, the terpene is a naturally occurring terpene. In some embodiments, the terpene is a non-naturally occurring terpene and/or a chemically modified terpene (e.g., saturated terpene, terpene amine, fluorinated terpene, or silylated terpene). Terpenes that are modified chemically, such as by oxidation or rearrangement of the carbon skeleton, may be referred to as terpenoids. Many references use “terpene” and “terpenoid” interchangeably, and this disclosure will adhere to that usage.

In some embodiments, the terpene is a non-oxygenated terpene. In some embodiments, the terpene is citrus terpene. In some embodiments, the terpene is d-limonene. In some embodiments, the terpene is dipentene. In some embodiments, the terpene is selected from the group consisting of d-limonene, nopol, alpha terpineol, eucalyptol, dipentene, linalool, alpha-pinene, beta-pinene, alpha-terpinene, geraniol, alpha-terpinyl acetate, menthol, menthone, cineole, citranellol, and combinations thereof. As used herein, “terpene” refers to a single terpene compound or a blend of terpene compounds.

In some embodiments, the emulsion or microemulsion may comprise an unsubstituted cyclic or acyclic, branched or unbranched alkane. In some embodiments, the cyclic or acyclic, branched or unbranched alkane has from 6 to 12 carbon atoms. Non-limiting examples of unsubstituted, acyclic, unbranched alkanes include hexane, heptane, octane, nonane, decane, undecane, dodecane, and combinations thereof. Non-limiting examples of unsubstituted, acyclic, branched alkanes include isomers of methylpentane (e.g., 2-methylpentane, 3-methylpentane), isomers of dimethylbutane (e.g., 2,2-dimethylbutane, 2,3-dimethylbutane), isomers of methylhexane (e.g., 2-methylhexane, 3-methylhexane), isomers of ethylpentane (e.g., 3-ethylpentane), isomers of dimethylpentane (e.g., 2,2,-dimethylpentane, 2,3-dimethylpentane, 2,4-dimethylpentane, 3,3-dimethylpentane), isomers of trimethylbutane (e.g., 2,2,3-trimethylbutane), isomers of methylheptane (e.g., 2-methylheptane, 3-methylheptane, 4-methylheptane), isomers of dimethylhexane (e.g., 2,2-dimethylhexane, 2,3-dimethylhexane, 2,4-dimethylhexane, 2,5-dimethylhexane, 3,3-dimethylhexane, 3,4-dimethylhexane), isomers of ethylhexane (e.g., 3-ethylhexane), isomers of trimethylpentane (e.g., 2,2,3-trimethylpentane, 2,2,4-trimethylpentane, 2,3,3-trimethylpentane, 2,3,4-trimethylpentane), isomers of ethylmethylpentane (e.g., 3-ethyl-2-methylpentane, 3-ethyl-3-methylpentane), and combinations thereof. Non-limiting examples of unsubstituted cyclic branched or unbranched alkanes include cyclohexane, methylcyclopentane, ethylcyclobutane, propylcyclopropane, isopropylcyclopropane, dimethylcyclobutane, cycloheptane, methylcyclohexane, dimethylcyclopentane, ethylcyclopentane, trimethylcyclobutane, cyclooctane, methylcycloheptane, dimethylcyclohexane, ethylcyclohexane, cyclononane, methylcyclooctane, dimethylcycloheptane, ethylcycloheptane, trimethylcyclohexane, ethylmethylcyclohexane, propylcyclohexane, cyclodecane, and combinations thereof. In some embodiments, the unsubstituted cyclic or acyclic, branched or unbranched alkane having from 6 to 12 carbon atoms is selected from the group consisting of heptane, octane, nonane, decane, 2,2,4-trimethylpentane (isooctane), and propylcyclohexane, and combinations thereof.

In some embodiments, the emulsion or microemulsion may comprise unsubstituted acyclic branched alkene or unsubstituted acyclic unbranched alkene having one or two double bonds and from 6 to 12 carbon atoms, or an unsubstituted acyclic branched alkene or unsubstituted acyclic unbranched alkene having one or two double bonds and from 6 to 10 carbon atoms. Non-limiting examples of unsubstituted acyclic unbranched alkenes having one or two double bonds and from 6 to 12 carbon atoms include isomers of hexene (e.g., 1-hexene, 2-hexene), isomers of hexadiene (e.g., 1,3-hexadiene, 1,4-hexadiene), isomers of heptene (e.g., 1-heptene, 2-heptene, 3-heptene), isomers of heptadiene (e.g., 1,5-heptadiene, 1-6, heptadiene), isomers of octene (e.g., 1-octene, 2-octene, 3-octene), isomers of octadiene (e.g., 1,7-octadiene), isomers of nonene, isomers of nonadiene, isomers of decene, isomers of decadiene, isomers of undecene, isomers of undecadiene, isomers of dodecene, isomers of dodecadiene, and combinations thereof. In some embodiments, the acyclic, unbranched alkene having one or two double bonds and from 6 to 12 carbon atoms is an alpha-olefin (e.g., 1-hexene, 1-heptene, 1-octene, 1-nonene, 1-decene, 1-undecene, 1-dodecene). Non-limiting examples of unsubstituted, acyclic, branched alkenes include isomers of methylpentene, isomers of dimethylpentene, isomers of ethylpentene, isomers of methylethylpentene, isomers of propylpentene, isomers of methylhexene, isomers of ethylhexene, isomers of dimethylhexene, isomers of methylethylhexene, isomers of methylheptene, isomers of ethylheptene, isomers of dimethylhexptene, isomers of methylethylheptene, and combinations thereof.

In some embodiments, the solvent blend comprises an aromatic solvent having a boiling point from about 300 to about 400 degrees Fahrenheit. Non-limiting examples of aromatic solvents having a boiling point from about 300 to about 400 degrees Fahrenheit include butylbenzene, hexylbenzene, mesitylene, light aromatic naphtha, heavy aromatic naphtha, and combinations thereof.

In some embodiments, the emulsion or microemulsion may comprise an aromatic solvent having a boiling point from about 175 to about 300 degrees Fahrenheit. Non-limiting examples of aromatic liquid solvents having a boiling point from about 175 to about 300 degrees Fahrenheit include benzene, xylenes, and toluene.

In some embodiments, the emulsion or microemulsion may comprise an aromatic compound. In some embodiments, the aromatic compound may be a solvent. The aromatic compounds may be natural or synthetic. Additional non-limiting examples of aromatic compounds include derivatized and underivatized naphthalene, anthracene, phenanthrene, pyrene, fluoranthene, benzopyrene, chrysene, perylene, phenol, catechol, aminophenol, coniferyl alcohol and esters thereof, synapyl alcohol, syringol, syringaldehyde, syringic acid, acetosyringone, sinapine, canolol, cannabinol, cannabidiol, derivatized phenols, phenolic natural products, phenolic resins, lignin, derivatized lignin, tributylphenol ethoxylate, derivatized cashew nut shell liquid, ethoxylated cashew nut shell liquid, and combinations thereof.

Suitable aromatic compounds can also be selected from, for example, polycondensed aromatic compounds, polycyclic aromatic compounds, derivatized phenols, phenolic natural products, phenolic resins, lignin-based compounds, derivatized lignin, naphthalenic, anthracenic and phenanthrenic compounds, compounds derived from cannabis, and combinations thereof. In some embodiments aromatic compounds can be heterocyclic compounds.

In some embodiments, the one or more aromatic compounds are selected from the group consisting of cardol, cardanol, anacardic acid, 2-methylcardol, and combinations thereof. Other non-limiting examples of aromatic compounds include natural phenolic plant-based derivatives such as those coming from the Rubus genus, gallic acid and/or derivatives thereof, thymol and/or derivatives thereof, pyrogallol and/or derivatives thereof, tannin and/or derivatives thereof, lignin and/or derivatives thereof, or combinations thereof.

Cashew Nut Shell Liquid

The non-aqueous phase may comprise one aromatic compound or more than one (e.g. multiple) aromatic compounds (e.g., two compounds, three compounds, etc.). In these embodiments, the one or more aromatic compounds are those typically found in cashew nut shell liquid (CNSL), for example, cardol, cardanol, anacardic acid, 2-methylcardol, or combinations thereof. In some embodiments, the CNSL or the aromatic compounds described above found in CNSL, may function as oil-soluble surfactants. In other words, some embodiments relate to CNSL that are distributed in the composition in a location other than a non-aqueous phase, such as at an interface between the non-aqueous phase and an aqueous phase.

Derivatized CNSL

In some embodiments, derivatized CNSL may be used in the composition. Derivatized CNSL is obtained as a result of chemical reaction between CNSL and various derivatization agents. One non-limiting example of a derivatized CNSL is ethoxylated CNSL.

Some non-limiting examples of CNSL derivatization can be found in D. Lomonaco, G. Mele, S. Mazzetto, “Cashew Nutshell Liquid (CNSL): From and Agro-industrial Waste to a Sustainable Alternative to Petrochemical Resources”, Chapter 2 in “Cashew Nut Shell Liquid: A Goldfield for Functional Materials”, Edited by Anikumar, P., Springer, 2017, each of which is incorporated herein by reference in its entirety and for all purposes. In some embodiments, the derivatized CNSL may comprise an ethoxylated CNSL with a degree of ethoxylation of less than or equal to 7 moles of ethylene oxide per mole of CNSL, which are typically insoluble in water, but may be soluble and be part of the non-aqueous phase.

In some embodiments, derivatized CNSL comprises derivatized cardol, derivatized cardanol, derivatized anacardic acid, derivatized 2-methylcardol, derivatized polymers thereof, CNSL-based surfactant, CNSL gemini surfactant, CNSL azo compounds, CNSL-based glycolipids, CNSL glucosides, sulfonated CNSL, sulfonated pentadecylphenols, sulfated pentadecylpolyphenols, alkoxylated CNSL, ethoxylated CNSL, propoxylated CNSL, ethoxylated-propoxylated CNSL, butoxylated CNSL, butoxylated-ethoxylated CNSL, CNSL polyols, CNSL-based Mannich polyols, CNSL esters, CNSL ethers, CNSL polyesters, CNSL polyethers, CNSL amino alcohols, CNSL amines, CNSL substituted amines, CNSL amides, CNSL carboxylates, CNSL phosphates, CNSL sulfonates, CNSL sulfates, CNSL phosphates, CNSL phosphonates, CNSL succinates, CNSL polyester diols, CNSL polyether diols, CNSL polyether triols, CNSL polyester triols, CNSL polyester polyethers, CNSL polyether polyols, CNSL polyester polyols, CNSL salt, CNSL quaternary ammonium salts, CNSL pyridinium salts, CNSL phosphonium salts, 2,4-sodium disulphonate-5-n-pentadecylphenol, 8-(3-methoxy)-phenyl-N,N,N-triethyl-1-(n)-octylammonium chloride, 8-(3-methoxy)-phenyl-N,N,N-triethyl-1-(n)-octylammonium bromide, 8-(3-methoxy)-phenyl-N,N,N-triethyl-1-(n)-octylammonium fluoride, 8-(3-methoxy)-phenyl-N,N,N-triethyl-1-(n)-octylammonium iodide, N-cardanyl taurine amide, cardanol oligomers, cardol oligomers, anacardic acid oligomers, 2-methyl cardol oligomers, CNSL diethyl phosphate, CNSL phthalocyanines, CNSL porphyrines, CNSL fullerenes, CNSL fullerpyrrolidines, biscardanol, biscardol, bisanacardic acid, bis-2-methlyl cardol, CNSL phosphate ester, 8-hydroxy-3-tridecyl-3,4-dihydroisochromen-1-one, 8-hydroxy-3-tridecyl-1H-isochromen-1-one, sodium cardanol sulfonate surfactant, a CNSL amine oxide, a CNSL betaine, a CNSL hydroxysultane, cardanol ethoxylate sulfosuccinate, cardanol ethoxylate sulfate, cardanol ethoxylate sulfonate, cardol ethoxylate sulfosuccinate, cardol ethoxylate sulfate, cardol ethoxylate sulfonate, 2-methyl cardol ethoxylate sulfosuccinate, 2-methylcardol ethoxylate sulfate, 2-methyl cardol ethoxylate sulfonate, anacardic acid ethoxylate sulfosuccinate, anacardic acid ethoxylate sulfate, anacardic acid ethoxylate sulfonate, sodium salts of anacardic acid, sodium salts of tetrahydroanacardic acid, N,N-dibutyl-3-pentadecyl cyclohexylamine, N,N-dimethyl-3-pentadecyl cyclohexylamine, N-benzyl-N,N-dimethyl-3-pentadecylcyclohexan-1-aminium, betaine 2-(dimethyl(3-pentadecylcyclohexyl)ammonio)acetate, 3-pentadecylphenol, and derivatized 3-pentadecylphenol.

In some embodiments, the 2-methylcardol comprises 2-methyl-5-pentadecylresorcinol, 2-methyl-5-(8′-pentadecenyl)resorcinol, 2-methyl-5-(8′, 11-pentadecadienyl)resorcinol, and 2-methyl-5-(8′, 11′, 14′-pentadecatrienyl)resorcinol.

In some embodiments, the derivatized 2-methylcardol comprises derivatized 2-methyl-5-pentadecylresorcinol, derivatized 2-methyl-5-(8-pentadecenyl)resorcinol, derivatized 2-methyl-5-(8′, 11′-pentadecadienyl)resorcinol, derivatized 2-methyl-5-(8′, 11′, 14′-pentadecatrienyl)resorcinol, and mixtures thereof.

In some embodiments, the derivatized CNSL comprises a halogenated CNSL. In some embodiments, the halogenated CNSL comprises chlorinated cardanol, chlorinated cardol, chlorinated anacardic acid, and chlorinated 2-methyl cardol. In some embodiments, the halogenated CNSL comprises fluorinated cardanol, fluorinated cardol, fluorinated anacardic acid, and fluorinated 2-methyl cardol. In some embodiments, the halogenated CNSL comprises brominated cardanol, brominated cardol, brominated anacardic acid, and brominated 2-methyl cardol. In some embodiments, the halogenated CNSL comprises iodine-substituted cardanol, iodine-substituted cardol, iodine-substituted anacardic acid, and iodine-substituted 2-methyl cardol.

In some embodiments, the derivatized CNSL comprises an olefin metathesis reaction product.

In some embodiments, the derivatized CNSL comprises a CNSL in which alcohol and/or acid groups have been converted into aldehyde, ketone or ester groups.

In some embodiments, the derivatized CNSL comprises a hydrogenated CNSL. In some embodiments, the hydrogenated CNSL comprises tetrahydroanacardic acid and 3-pentadecylphenol. In some embodiments, the derivatized CNSL comprises 3-pentadecylphenol.

In some embodiments, the derivatized CNSL comprises derivatized CNSL resin, CNSL formaldehyde resin, CNSL phenol formaldehyde resin, CNSL cardanol formaldehyde resin, CNSL hexamine resin, CNSL cardanol hexamine resin, 3-pentadecylphenol resin. In some embodiments, the derivatized CNSL resin comprises Novolac resins and Resoles resins.

In some embodiments, the derivatized CNSL comprises oxidized CNSL.

In some embodiments, the derivatized CNSL comprises polymerized CNSL.

In some embodiments, the derivatized CNSL comprises CNSL reacted with nitric acid and/or nitrous acid.

In some embodiments, the derivatized CNSL comprises CNSL isocyanates.

In some embodiments, the derivatized CNSL comprises CNSL which is pH-adjusted CNSL.

Amine Solvents

In some embodiments, the emulsion or microemulsion may comprise an amine of the formula NR¹R²R³, wherein R¹, R², and R³ are the same or different and are C₁₋₁₆ alkyl groups that are (i) branched or unbranched; (ii) cyclic or acyclic; and (iii) substituted or unsubstituted. In some embodiments any two of R¹, R², and R³ are joined together to form a ring. In some embodiments, each of R¹, R², and R³ are the same or different and are hydrogen or alkyl groups that are (i) branched or unbranched; (ii) cyclic or acyclic; and (iii) substituted or unsubstituted. In some embodiments, any two of R¹, R², and R³ are joined together to form a ring, provided at least one of R′, R², and R³ is a methyl or an ethyl group. In some embodiments, R¹ is C₁-C₆ alkyl group that is (i) branched or unbranched; (ii) cyclic or acyclic; and (iii) substituted or unsubstituted and R² and R³ are hydrogen or a C₈₋₁₆ alkyl group that is (i) branched or unbranched; (ii) cyclic or acyclic; and (iii) substituted or unsubstituted. In some embodiments, R² and R³ may be joined together to form a ring. In some embodiments, R¹ is a methyl or an ethyl group and R² and R³ are the same or different and are C₈₋₁₆ alkyl groups that are (i) branched or unbranched; (ii) cyclic or acyclic; and (iii) substituted or unsubstituted. In some embodiments R² and R³ may be joined together to form a ring. In some embodiments, R¹ is a methyl group and R² and R³ are the same or different and are hydrogen or C₈₋₁₆ alkyl groups that are (i) branched or unbranched; (ii) cyclic or acyclic; and (iii) substituted or unsubstituted. In some embodiments R² and R³ may be joined together to form a ring. In some embodiments, R¹ and R² are the same or different and are hydrogen or C₁-C₆ alkyl groups that are (i) branched or unbranched; (ii) cyclic or acyclic; and (iii) substituted or unsubstituted and R³ is a C₈₋₁₆ alkyl group that is (i) branched or unbranched; (ii) cyclic or acyclic; and (iii) substituted or unsubstituted. In some embodiments, R¹ and R² are the same or different and are a methyl or an ethyl group and R³ is hydrogen or a C₈₋₁₆ alkyl group that is (i) branched or unbranched; (ii) cyclic or acyclic; and (iii) substituted or unsubstituted. In some embodiments, R¹ and R² are methyl groups and R³ is hydrogen or a C₈₋₁₆ alkyl group that is (i) branched or unbranched; (ii) cyclic or acyclic; and (iii) substituted or unsubstituted.

In some embodiments, the amine is of the formula NR¹R²R³, wherein R¹ is methyl and R² and R³ are C₈₋₁₆ alkyl groups that are (i) branched or unbranched; (ii) cyclic or acyclic; and (iii) substituted or unsubstituted. In some embodiments R² and R³ are joined together to form a ring. Non-limiting examples of amines include isomers of N-methyl-octylamine, isomers of N-methyl-nonylamine, isomers of N-methyl-decylamine, isomers of N-methylundecylamine, isomers of N-methyldodecylamine, isomers of N-methyl teradecylamine, isomers of N-methyl-hexadecylamine, and combinations thereof. In some embodiments, the amine is N-methyl-decylamine, N-methyl-hexadecylamine, or a combination thereof.

In some embodiments, the amine is of the formula NR¹R²R³, wherein R¹ is a methyl group and R² and R³ are the same or different and are C₈₋₁₆ alkyl groups that are (i) branched or unbranched; (ii) cyclic or acyclic; and (iii) substituted or unsubstituted. In some embodiments R² and R³ are joined together to form a ring. Non-limiting examples of amines include isomers of N-methyl-N-octyloctylamine, isomers of N-methyl-N-nonylnonylamine, isomers of N-methyl-N-decyldecylamine, isomers of N-methyl-N-undecylundecylamine, isomers of N-methyl-N-dodecyldodecylamine, isomers of N-methyl-N-tetradecylteradecylamine, isomers of N-methyl-N-hexadecylhexadecylamine, isomers of N-methyl-N-octylnonylamine, isomers of N-methyl-N-octyldecylamine, isomers of N-methyl-N-octyldodecylamine, isomers of N-methyl-N-octylundecylamine, isomers of N-methyl-N-octyltetradecylamine, isomers of N-methyl-N-octylhexadecylamine, N-methyl-N-nonyldecylamine, isomers of N-methyl-N-nonyldodecylamine, isomers of N-methyl-N-nonyltetradecylamine, isomers of N-methyl-N-nonylhexadecylamine, isomers of N-methyl-N-decylundecylamine, isomers of N-methyl-N-decyldodecylamine, isomers of N-methyl-N-decyltetradecylamine, isomers of N-methyl-N-decylhexadecylamine, isomers of N-methyl-N-dodecylundecylamine, isomers of N-methyl-N-dodecyltetradecylamine, isomers of N-methyl-N-dodecylhexadecylamine, isomers of N-methyl-N-tetradecylhexadecylamine, and combinations thereof. In some embodiments, the amine is selected from the group consisting of N-methyl-N-octyloctylamine, isomers of N-methyl-N-nonylnonylamine, isomers of N-methyl N-decyldecylamine, isomers of N-methyl-N-undecylundecylamine, isomers of N-methyl-N-dodecyldodecylamine, isomers of N-methyl-N-tetradecylteradecylamine, and isomers of N-methyl-N-hexadecylhexadecylamine, and combinations thereof. In some embodiments, the amine is N-methyl-N-dodecyldodecylamine, one or more isomers of N-methyl-N-hexadecylhexadecylamine, or combinations thereof. In some embodiments, the amine is selected from the group consisting of isomers of N-methyl-N-octylnonylamine, isomers of N-methyl-N-octyldecylamine, isomers of N-methyl-N-octyldodecylamine, isomers of N-methyl-N-octylundecylamine, isomers of N-methyl-N-octyltetradecylamine, isomers of N-methyl-N-octylhexadecylamine, N-methyl-N-nonyldecylamine, isomers of N-methyl-N-nonyldodecylamine, isomers of N-methyl-N-nonyltetradecylamine, isomers of N-methyl-N-nonylhexadecylamine, isomers of N-methyl-N-decyldodecylamine, isomers of N-methyl-N-decylundecylamine, isomers of N-methyl-N-decyldodecylamine, isomers of N-methyl-N-decyltetradecylamine, isomers of N-methyl-N-decylhexadecylamine, isomers of N-methyl-N-dodecylundecylamine, isomers of N-methyl-N-dodecyltetradecylamine, isomers of N-methyl-N-dodecylhexadecylamine, isomers of N-methyl-N-tetradecylhexadecylamine, and combinations thereof. In some embodiments, the cyclic or acyclic, branched or unbranched tri-substituted amine is selected from the group consisting of N-methyl-N-octyldodecylamine, N-methyl-N-octylhexadecylamine, and N-methyl-N-dodecylhexadecylamine, and combinations thereof.

In some embodiments, the amine is of the formula NR¹R²R³, wherein R¹ and R² are methyl and R³ is a C₈₋₁₆ alkyl that is (i) branched or unbranched; (ii) cyclic or acyclic; and (iii) substituted or unsubstituted. Non-limiting examples of amines include isomers of N,N-dimethylnonylamine, isomers of N,N-dimethyldecylamine, isomers of N,N-dimethylundecylamine, isomers of N,N-dimethyldodecylamine, isomers of N,N-dimethyltetradecylamine, and isomers of N,N-dimethylhexadecylamine. In some embodiments, the amine is selected from the group consisting of N,N-dimethyldecylamine, isomers of N,N-dodecylamine, and isomers of N,N-dimethylhexadecylamine.

Amide Solvents

In some embodiments, the emulsion or microemulsion may comprise an amide solvent. In some embodiments, the amide is of the formula N(C═OR⁴)R⁵R⁶, wherein R⁴, R⁵, and R⁶ are the same or different and are hydrogen or C₄₋₁₆ alkyl groups wherein the alkyl groups are (i) branched or unbranched; (ii) cyclic or acyclic; and (iii) substituted or unsubstituted. In some embodiments R⁵ and R⁶ are joined together to form a ring. In some embodiments, each of R⁴, R⁵, and R⁶ are the same or different and are hydrogen or C₄₋₁₆ alkyl groups wherein the alkyl groups are (i) branched or unbranched; (ii) cyclic or acyclic; and (iii) substituted or unsubstituted, provided at least one of R⁴, R⁵, and R⁶ is a methyl or an ethyl group. In some embodiments R⁵ and R⁶ are joined together to form a ring. In some embodiments, R⁴ is hydrogen, C₁-C₆ alkyl, wherein the alkyl group is (i) branched or unbranched; (ii) cyclic or acyclic; and (iii) substituted or unsubstituted, and R⁵ and R⁶ are the same or different and are hydrogen or C₈₋₁₆ alkyl groups wherein the alkyl groups are (i) branched or unbranched; (ii) cyclic or acyclic; and (iii) substituted or unsubstituted. In some embodiments, R⁵ and R⁶ are joined together to form a ring. In some embodiments, R⁴ is hydrogen, methyl, or ethyl and R⁵ and R⁶ are C₈₋₁₆ alkyl groups wherein the alkyl groups are (i) branched or unbranched; (ii) cyclic or acyclic; and (iii) substituted or unsubstituted. In some embodiments, R⁵ and R⁶ are joined together to form a ring. In some embodiments, R⁴ is hydrogen and R⁵ and R⁶ are the same or different and are C₈₋₁₆ alkyl groups wherein the alkyl groups are (i) branched or unbranched; (ii) cyclic or acyclic; and (iii) substituted or unsubstituted. In some embodiments R⁵ and R⁶ are joined together to form a ring. In some embodiments, R⁴ and R⁵ are the same or different and are hydrogen or C₁-C₆ alkyl groups wherein the alkyl groups are (i) branched or unbranched; (ii) cyclic or acyclic; and (iii) substituted or unsubstituted and R⁶ is a C₈₋₁₆ alkyl group that is (i) branched or unbranched; (ii) cyclic or acyclic; and (iii) substituted or unsubstituted. In some embodiments, R⁴ and R⁵ are the same or different and are independently hydrogen, methyl, or ethyl and R⁶ is a C₈₋₁₆ alkyl group that is (i) branched or unbranched; (ii) cyclic or acyclic; and (iii) substituted or unsubstituted. In some embodiments, R⁴ and R⁵ are hydrogen and R⁶ is a C₈₋₁₆ alkyl group that is (i) branched or unbranched; (ii) cyclic or acyclic; and (iii) substituted or unsubstituted. In some embodiments, R⁶ is hydrogen or R⁶ is a C₁₋₆ alkyl group that is (i) branched or unbranched; (ii) cyclic or acyclic; and (iii) substituted or unsubstituted and R⁴ and R⁵ are the same or different and are C₈₋₁₆ alkyl groups wherein the alkyl groups are (i) branched or unbranched; (ii) cyclic or acyclic; and (iii) substituted or unsubstituted. In some embodiments, R⁶ is hydrogen, methyl, or ethyl and R⁴ and R⁵ are the same or different and are C₈₋₁₆ alkyl groups wherein the alkyl groups are (i) branched or unbranched; (ii) cyclic or acyclic; and (iii) substituted or unsubstituted. In some embodiments, R⁶ is hydrogen and R⁴ and R⁵ are the same or different and are C₈₋₁₆ alkyl groups wherein the alkyl groups are (i) branched or unbranched; (ii) cyclic or acyclic; and (iii) substituted or unsubstituted. In some embodiments, R⁵ and R⁶ are the same or different and are hydrogen or C₁₋₆ alkyl groups wherein the alkyl groups are (i) branched or unbranched; (ii) cyclic or acyclic; and (iii) substituted or unsubstituted, and R⁴ is a C₈₋₁₆ alkyl group that is (i) branched or unbranched; (ii) cyclic or acyclic; and (iii) substituted or unsubstituted. In some embodiments, R⁵ and R⁶ are the same or different and are independently hydrogen, methyl, or ethyl and R⁴ is a C₈₋₁₆ alkyl group that is (i) branched or unbranched; (ii) cyclic or acyclic; and (iii) substituted or unsubstituted. In some embodiments, R⁵ and R⁶ are hydrogen and R⁴ is a C₈₋₁₆ alkyl group that is (i) branched or unbranched; (ii) cyclic or acyclic; and (iii) substituted or unsubstituted.

In some embodiments, the amide is of the formula N(C═OR⁴)R⁵R⁶, wherein each of R⁴, R⁵, and R⁶ are the same or different and are C₄₋₁₆ alkyl groups wherein the alkyl groups are (i) branched or unbranched; (ii) cyclic or acyclic; and (iii) substituted or unsubstituted. In some embodiments R⁵ and R⁶ are joined together to form a ring. In some embodiments, the amide is of the formula N(C═OR⁴)R⁵R⁶, wherein each of R⁴, R⁵, and R⁶ are the same or different and are C₈₋₁₆ alkyl groups wherein the alkyl groups are (i) branched or unbranched; (ii) cyclic or acyclic; and (iii) substituted or unsubstituted. In some embodiments R⁵ and R⁶ are joined together to form a ring. Non-limiting examples of amides include N,N-dioctyloctamide, N,N-dinonylnonamide, N,N-didecyldecamide, N,N-didodecyldodecamide, N,N-diundecylundecamide, N,N-ditetradecyltetradecamide, N,N-dihexadecylhexadecamide, N,N-didecyloctamide, N,N-didodecyloctamide, N,N-dioctyldodecamide, N,N-didecyldodecamide, N,N-dioctylhexadecamide, N,N-didecylhexadecamide, N,N-didodecylhexadecamide, and combinations thereof. In some embodiments, the amide is N,N-dioctyldodecamide, N,N-didodecyloctamide, or a combination thereof.

In some embodiments, the amide is of the formula N(C═OR⁴)R⁵R⁶, wherein R⁶ is selected from the group consisting of hydrogen, methyl, ethyl, propyl and isopropyl, and R⁴ and R⁵ are the same or different and are C₄₋₁₆ alkyl groups wherein the alkyl groups are (i) branched or unbranched; (ii) cyclic or acyclic; and (iii) substituted or unsubstituted. In some embodiments, R⁶ is selected from the group consisting of hydrogen, methyl, ethyl, propyl and isopropyl, and R⁴ and R⁵ are the same or different and are C₄₋₈ alkyl groups wherein the alkyl groups are (i) branched or unbranched; (ii) cyclic or acyclic; and (iii) substituted or unsubstituted. In some embodiments, at least one of R⁴ and R⁵ is substituted with a hydroxyl group. In some embodiments, at least one of R⁴ and R⁵ is C₁₋₁₆ alkyl substituted with a hydroxyl group.

In some embodiments, the amide is of the formula N(C═OR⁴)R⁵R⁶, wherein R⁶ is C₁-C₃ alkyl and R⁴ and R⁵ are the same or different and are C₄₋₁₆ alkyl groups that are (i) branched or unbranched; (ii) cyclic or acyclic; and (iii) substituted or unsubstituted. In some embodiments, R⁶ is selected from the group consisting of methyl, ethyl, propyl, and isopropyl, and R⁴ and R⁵ are the same or different and are C₄₋₁₆ alkyl groups that are (i) branched or unbranched; (ii) cyclic or acyclic; and (iii) substituted or unsubstituted. In some embodiments, R⁶ is selected from the group consisting of methyl, ethyl, propyl, and isopropyl, and R⁴ and R⁵ are the same or different and are C₈₋₁₆ alkyl groups that are (i) branched or unbranched; (ii) cyclic or acyclic; and (iii) substituted or unsubstituted. In some embodiments, at least one of R⁴ and R⁵ is substituted with a hydroxyl group. In some embodiments, R⁶ is selected from the group consisting of methyl, ethyl, propyl, and isopropyl, and R⁴ and R⁵ are the same or different and are C₄₋₁₆ alkyl groups that are (i) branched or unbranched; (ii) cyclic or acyclic; and (iii) substituted or unsubstituted. In some embodiments at least one of R⁴ and R⁵ is C₁₋₁₆ alkyl substituted with a hydroxyl group.

Non-limiting examples of amides include N,N-di-tert-butylformamide, N,N-dipentylformamide, N,N-dihexylformamide, N,N-diheptylformamide, N,N-dioctylformamide, N,N-dinonylformamide, N,N-didecylformamide, N,N-diundecylformamide, N,N-didodecylformamide, N,N-dihydroxymethylformamide, N,N-di-tert-butylacetamide, N,N-dipentylacetamide, N,N-dihexylacetamide, N,N-diheptylacetamide, N,N-dioctylacetamide, N,N-dinonylacetamide, N,N-didecylacetamide, N,N-diundecylacetamide, N,N-didodecylacetamide, N,N-dihydroxymethylacetamide, N,N-dimethylpropionamide, N,N-diethylpropionamide, N,N-dipropylpropionamide, N,N-di-n-propylpropionamide N,N-diisopropylpropionamide, N,N-dibutylpropionamide, N,N-di-n-butylpropionamide, N,N-di-sec-butylpropionamide, N,N-diisobutylpropionamide or N,N-di-tert-butylpropionamide, N,N-dipentylpropionamide, N,N-dihexylpropionamide, N,N-diheptylpropionamide, N,N-dioctylpropionamide, N,N-dinonylpropionamide, N,N-didecylpropionamide, N,N-diundecylpropionamide, N,N-didodecylpropionamide, N,N-dimethyl-n-butyramide, N,N-diethyl-n-butyramide, N,N-dipropyl-n-butyramide, N,N-di-n-propyl-n-butyramide or N,N-diisopropyl-n-butyramide, N,N-dibutyl-n-butyramide, N,N-di-n-butyl-n-butyramide, N,N-di-sec-butyl-n-butyramide, N,N-diisobutyl-n-butyramide, N,N-di-tert-butyl-n-butyramide, N,N-dipentyl-n-butyramide, N,N-dihexyl-n-butyramide, N,N-diheptyl-n-butyramide, N,N-dioctyl-n-butyramide, N,N-dinonyl-n-butyramide, N,N-didecyl-n-butyramide, N,N-diundecyl-n-butyramide, N,N-didodecyl-n-butyramide, N,N-dipentylisobutyramide, N,N-dihexylisobutyramide, N,N-diheptylisobutyramide, N,N-dioctylisobutyramide, N,N-dinonylisobutyramide, N,N-didecylisobutyramide, N,N-diundecylisobutyramide, N,N-didodecylisobutyramide, N,N-pentylhexylformamide, N,N-pentylhexylacetamide, N,N-pentylhexylpropionamide, N,N-pentylhexyl-n-butyramide, N,N-pentylhexylisobutyramide, N,N-methylethylpropionamide, N,N-methyl-n-propylpropionamide, N,N-methylisopropylpropionamide, N,N-methyl-n-butylpropionamide, N,N-methylethyl-n-butyramide, N,N-methyl-n-butyramide, N,N-methylisopropyl-n-butyramide, N,N-methyl-n-butyl-n-butyramide, N,N-methylethylisobutyramide, N,N-methyl-n-propylisobutyramide, N,N-methylisopropylisobutyramide, and N,N-methyl-n-butylisobutyramide. In some embodiments, the amide is selected from the group consisting of N,N-dioctyldodecacetamide, N,N-methyl-N-octylhexadecdidodecylacetamide, N-methyl-N-hexadecyldodecylhexadecacetamide, and combinations thereof.

In some embodiments, the amide is of the formula N(C═OR⁴)R⁵R⁶, wherein R⁶ is hydrogen or a methyl group and R⁴ and R⁵ are C₈₋₁₆ alkyl groups that are (i) branched or unbranched; (ii) cyclic or acyclic; and (iii) substituted or unsubstituted. Non-limiting amides include isomers of N-methyloctamide, isomers of N-methylnonamide, isomers of N-methyldecamide, isomers of N-methylundecamide, isomers of N methyldodecamide, isomers of N methylteradecamide, and isomers of N-methyl-hexadecamide. In some embodiments, the amides are selected from the group consisting of N-methyloctamide, N-methyldodecamide, N-methylhexadecamide, and combinations thereof.

Non-limiting amides include isomers of N-methyl-N-octyloctamide, isomers of N-methyl-N-nonylnonamide, isomers of N-methyl-N-decyldecamide, isomers of N methyl-N undecylundecamide, isomers of N methyl-N-dodecyldodecamide, isomers of N methyl N-tetradecylteradecamide, isomers of N-methyl-N-hexadecylhdexadecamide, isomers of N-methyl-N-octylnonamide, isomers of N-methyl-N-octyldecamide, isomers of N-methyl-N-octyldodecamide, isomers of N-methyl-N-octylundecamide, isomers of N-methyl-N-octyltetradecamide, isomers of N-methyl-N-octylhexadecamide, N-methyl-N-nonyldecamide, isomers of N-methyl-N-nonyldodecamide, isomers of N-methyl-N-nonyltetradecamide, isomers of N-methyl-N-nonylhexadecamide, isomers of N-methyl-N-decyldodecamide, isomers of N methyl-N-decylundecamide, isomers of N-methyl-N-decyldodecamide, isomers of N-methyl-N-decyltetradecamide, isomers of N-methyl-N-decylhexadecamide, isomers of N methyl-N-dodecylundecamide, isomers of N methyl-N-dodecyltetradecamide, isomers of N-methyl-N-dodecylhexadecamide, isomers of N methyl-N-tetradecylhexadecamide, and combinations thereof. In some embodiments, the amide is selected from the group consisting of isomers of N-methyl-N-octyloctamide, isomers of N-methyl-N-nonylnonamide, isomers of N-methyl-N-decyldecamide, isomers of N methyl-N undecylundecamide, isomers of N methyl-N-dodecyldodecamide, isomers of N methyl N-tetradecylteradecamide, isomers of N-methyl-N-hexadecylhdexadecamide, and combinations thereof. In some embodiments, amide is selected from the group consisting of N-methyl-N-octyloctamide, N methyl-N-dodecyldodecamide, and N-methyl-N-hexadecylhexadecamide. In some embodiments, the amide is selected from the group consisting of isomers of N-methyl-N-octylnonamide, isomers of N-methyl-N-octyldecamide, isomers of N-methyl-N-octyldodecamide, isomers of N-methyl-N-octylundecamide, isomers of N-methyl-N-octyltetradecamide, isomers of N-methyl-N-octylhexadecamide, N-methyl-N-nonyldecamide, isomers of N-methyl-N-nonyldodecamide, isomers of N-methyl-N-nonyltetradecamide, isomers of N-methyl-N-nonylhexadecamide, isomers of N-methyl-N-decyldodecamide, isomers of N methyl-N-decylundecamide, isomers of N-methyl-N-decyldodecamide, isomers of N-methyl-N-decyltetradecamide, isomers of N-methyl-N-decylhexadecamide, isomers of N methyl-N-dodecylundecamide, isomers of N methyl-N-dodecyltetradecamide, isomers of N-methyl-N-dodecylhexadecamide, and isomers of N methyl-N-tetradecylhexadecamide. In some embodiments, the amide is selected from the group consisting of N-methyl-N-octyldodecamide, N-methyl-N-octylhexadecamide, and N-methyl-N-dodecylhexadecamide.

In some embodiments, the amide is of the formula N(C═OR⁴)R⁵R⁶, wherein R⁵ and R⁶ are the same or different and are hydrogen or C₁-C₃ alkyl groups and R⁴ is a C₄₋₁₆ alkyl group that is (i) branched or unbranched; (ii) cyclic or acyclic; and (iii) substituted or unsubstituted. In some embodiments, R⁵ and R⁶ are the same or different and are selected from the group consisting of hydrogen, methyl, ethyl, propyl and isopropyl, and R⁴ is a C₄₋₁₆ alkyl group that is (i) branched or unbranched; (ii) cyclic or acyclic; and (iii) substituted or unsubstituted. In some embodiments, R⁵ and R⁶ are the same or different and are selected from the group consisting of hydrogen, methyl, ethyl, propyl and isopropyl and R⁴ is a C₈₋₁₆ alkyl group that is (i) branched or unbranched; (ii) cyclic or acyclic; and (iii) substituted or unsubstituted. In some embodiments, R⁴ is substituted with a hydroxyl group. In some embodiments, R⁵ and R⁶ are the same or different and are selected from the group consisting of hydrogen, methyl, ethyl, propyl, and isopropyl, and R⁴ is selected from the group consisting of tert-butyl and C₅₋₁₆ alkyl groups that are (i) branched or unbranched; (ii) cyclic or acyclic; and (iii) substituted or unsubstituted, and C₁₋₁₆ alkyl groups that are (i) branched or unbranched; (ii) cyclic or acyclic; and (iii) substituted with a hydroxyl group.

In some embodiments, the amide is of the formula N(C═OR⁴)R⁵R⁶, wherein R⁵ and R⁶ are methyl groups and R⁴ is a C₈₋₁₆ alkyl group that is (i) branched or unbranched; (ii) cyclic or acyclic; and (iii) substituted or unsubstituted. Non-limiting examples of amides include isomers of N,N-dimethyloctamide, isomers of N,N-dimethylnonamide, isomers of N,N-dimethyldecamide, isomers of N,N-dimethylundecamide, isomers of N,N-dimethyldodecamide, isomers of N,N-dimethyltetradecamide, isomers of N,N-dimethylhexadecamide, and combinations thereof. In some embodiments, the cyclic or acyclic, branched or unbranched tri-substituted amines is selected from the group consisting of N,N-dimethyloctamide, N,N-dodecamide, and N,N-dimethylhexadecamide.

In some embodiments, a solvent (e.g., a terpene) may be extracted from a natural source (e.g., citrus, pine), and may comprise one or more impurities present from the extraction process. In some embodiments, the solvent comprises a crude cut (e.g., uncut crude oil, e.g., made by settling, separation, heating, etc.). In some embodiments, the solvent is a crude oil (e.g., naturally occurring crude oil, uncut crude oil, crude oil extracted from the wellbore, synthetic crude oil, crude citrus oil, crude pine oil, eucalyptus, etc.). In some embodiments, the solvent comprises a citrus extract (e.g., crude orange oil, orange oil, etc.). In some embodiments, the solvent is a citrus extract (e.g., crude orange oil, orange oil, etc.).

Aqueous Phase

In some embodiments, an emulsion or microemulsion comprises an aqueous phase. Generally, the aqueous phase comprises water. The water may be provided from any suitable source (e.g., sea water, fresh water, deionized water, reverse osmosis water, water from field production). In some embodiments, the emulsion or microemulsion comprises from about 1 wt % to about 60 wt %, or from about 10 wt % to about 55 wt %, or from about 15 wt % to about 45 wt %, or from about 25 wt % to about 45 wt % of water, or from about 5 wt % to about 75 wt % versus the total weight of the emulsion or microemulsion composition. In some embodiments, the surfactant and one or more solvents may be provided at select wt % as described herein, and the remainder of the composition may be the aqueous phase (e.g., water). The aqueous phase may comprise dissolved salts. Non-limiting examples of dissolved salts include salts comprising K, Na, Br, Cr, Cs, or Bi, for example, halides of these metals, including NaCl, KCl, CaCl₂, MgCl, and combinations thereof.

Surfactants

Generally, the emulsion or microemulsion comprises a surfactant. In some embodiments, the emulsion or microemulsion comprises a first surfactant and a second surfactant. In some embodiments the emulsion or microemulsion comprises a first surfactant and a co-surfactant. In some embodiments, the emulsion or microemulsion comprises a first surfactant, a second surfactant and a co-surfactant. The term surfactant is given its ordinary meaning in the art and generally refers to compounds having an amphiphilic structure which gives them a specific affinity for oil/water-type and water/oil-type interfaces. In some embodiments, the affinity helps the surfactants to reduce the free energy of these interfaces and to stabilize the dispersed phase of an emulsion or microemulsion.

The term surfactant includes but is not limited to nonionic surfactants, anionic surfactants, cationic surfactants, amphoteric surfactants, zwitterionic surfactants, switchable surfactants, cleavable surfactants, dimeric or gemini surfactants, glucamide surfactants, alkylpolyglycoside surfactants, extended surfactants containing a nonionic spacer arm central extension and an ionic or nonionic polar group, and combinations thereof. Nonionic surfactants generally do not contain any charges. Anionic surfactants generally possess a net negative charge. Cationic surfactants generally possess a net positive charge. Amphoteric surfactants generally have both positive and negative charges, however, the net charge of the surfactant can be positive, negative, or neutral, depending on the pH of the solution. Zwitterionic surfactants are generally not pH dependent. A zwitterion is a neutral molecule with a positive and a negative electrical charge, though multiple positive and negative charges can be present.

“Extended surfactants” are defined herein to be surfactants having propoxylated/ethoxylated spacer arms. The extended chain surfactants are intramolecular mixtures having at least one hydrophilic portion and at least one lipophilic portion with an intermediate polarity portion in between the hydrophilic portion and the lipophilic portion; the intermediate polarity portion may be referred to as a spacer. They attain high solubilization in the single phase emulsion or microemulsion, and are in some instances, insensitive to temperature and are useful for a wide variety of oil types, such as natural or synthetic polar oil types in a non-limiting embodiment. More information related to extended chain surfactants may be found in U.S. Pat. No. 8,235,120, which is incorporated herein by reference in its entirety.

The term co-surfactant as used herein is given its ordinary meaning in the art and refers to compounds (e.g., pentanol) that act in conjunction with surfactants to form an emulsion or microemulsion.

In some embodiments, the one or more surfactants is a surfactant described in U.S. patent application Ser. No. 14/212,731, filed Mar. 14, 2014, entitled “METHODS AND COMPOSITIONS FOR USE IN OIL AND/OR GAS WELLS,” now published as US/2014/0284053 on Sep. 25, 2014, herein incorporated by reference. In some embodiments, the surfactant is a surfactant described in U.S. patent application Ser. No. 14/212,763, filed Mar. 14, 2014, entitled “METHODS AND COMPOSITIONS FOR USE IN OIL AND/OR GAS WELLS,” now published as US/2014/0338911 on Nov. 20, 2014, and granted on Feb. 26, 2004 as U.S. Pat. No. 9,884,988 herein incorporated by reference.

In some embodiments, the emulsion or microemulsion comprises from about 1 wt % to about 50 wt %, or from about 1 wt % to about 40 wt %, or from about 1 wt % to about 35 wt %, or from about 5 wt % to about 40 wt %, or from about 5 wt % to about 35 wt %, or from about 10 wt % to about 30 wt %, or from about 10 wt % to about 20 wt % of the surfactant versus the total weight of the emulsion or microemulsion.

In some embodiments, the surfactants described herein in conjunction with solvents, generally form emulsions or microemulsions that may be diluted to a use concentration to form an oil-in-water nanodroplet dispersion. In some embodiments, the surfactants generally have hydrophile-lipophile balance (HLB) values from about 8 to about 18 or from about 8 to about 14.

Suitable surfactants for use with the compositions and methods are generally described herein. In some embodiments, the surfactant comprises a hydrophilic hydrocarbon surfactant.

In some embodiments, the surfactant comprises a nonionic surfactant. In some embodiments, the surfactant is a nonionic alkoxylated aliphatic alcohol having from 3 to 40 ethylene oxide (EO) units and from 0 to 20 propylene oxide (PO) units. The term aliphatic alcohol generally refers to a branched or linear, saturated or unsaturated aliphatic moiety having from 6 to 18 carbon atoms. In some embodiments, the surfactant is a nonionic alkoxylated aliphatic alcohol having from 3 to 40 ethylene oxide (EO) units.

In some embodiments, the hydrophilic hydrocarbon surfactant comprises an alcohol ethoxylate, wherein the alcohol ethoxylate contains a hydrocarbon group of 10 to 18 carbon atoms and contains an ethoxylate group of 5 to 12 ethylene oxide units.

In some embodiments, the surfactant is selected from the group consisting of ethoxylated fatty acids, ethoxylated fatty amines, and ethoxylated fatty amides wherein the fatty portion is a branched or linear, saturated or unsaturated aliphatic hydrocarbon moiety having from 6 to 18 carbon atoms.

In some embodiments, the surfactant is an alkoxylated castor oil. In some embodiments, the surfactant is a sorbitan ester derivative. In some embodiments the surfactant is an ethylene oxide-propylene oxide copolymer wherein the total number of EO and PO units is from 8 to 40 units. In some embodiments, the surfactant is an alkoxylated tristyryl phenol containing from 6 to 100 total ethylene oxide (EO) and propylene oxide (PO) units.

In some embodiments, the surfactant is an amine-based surfactant selected from the group consisting of ethoxylated alkylene amines, ethoxylated alkyl amines, propoxylated alkylene amines, propoxylated alkyl amines, ethoxylated-propoxylated alkylene amines and ethoxylated propoxylated alkyl amines. The ethoxylated/propoxylated alkylene or alkyl amine surfactant component preferably includes more than one nitrogen atom per molecule. Suitable amines include ethylenediaminealkoxylate and diethylenetriaminealkoxylate.

In some embodiments, the surfactant includes an alkanolamide surfactant. In some embodiments, the surfactant includes an alkanolamide surfactant that is a (C₆-C₁₈) aliphatic amide having groups R¹ and R² substituted on the amide nitrogen, wherein R¹ and R² are each independently selected from the group consisting of —H, —(C₁-C₁₈) aliphatic hydrocarbon, —(C₂H₄O)ₙH, —(C₃H₆O)ₙH, —(C₂H₄O)ₙ(C₃H₆O)ₘH, and (C₁-C₁₈) aliphatic alcohol, and n is about 1 to about 50 and m is 0 to about 20, wherein at least one of R¹ and R² is —(C₂H₄O)ₙH, —(C₃H₆O)ₙH, —(C₂H₄O)ₙ(C₃H₆O)ₘH, or (C₁-C₁₈) aliphatic alcohol, and n is about 1 to about 50 and m is 0 to about 20.

In some embodiments, the surfactant includes N,N-bis(hydroxyethyl)coco amides, N,N-bis(hydroxyethyl)coco fatty acid amides, cocamide DEA, cocamide diethanolamine, coco diethanolamides, coco diethanolamine, coco fatty acid diethanolamides, coconut DEA, coconut diethanolamides, coconut oil diethanolamides, coconut oil diethanolamine, lauric diethanolamide, or lauramide DEA. In some embodiments the surfactant includes an alkoxylated cocamide DEA, alkoxyated lauramide DEA, ethoxylated cocamide DEA, or ethoxylated lauramide DEA.

The alkanolamide surfactant can have the structure:

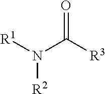

wherein R³ is a C₆-C₁₈ aliphatic hydrocarbon group, and wherein R¹ and R² are each independently selected from the group consisting of —H, —(C₁-C₁₈) aliphatic hydrocarbon, —(C₂H₄O)ₙH, —(C₃H₆O)ₙH, —(C₂H₄O)ₙ(C₃H₆O)ₘH, and n is about 1 to about 50 and m is 0 to about 20, wherein at least one of R¹ and R² is —(C₂H₄O)ₙH, —(C₃H₆O)ₙH, —(C₂H₄O)ₙ(C₃H₆O)ₘH, or (C₁-C₁₈) aliphatic alcohol, and n is about 1 to about 50 and m is 0 to about 20.

In some embodiments the surfactant is an alkoxylated polyimine with a relative solubility number (RSN) in the range of 5-20. As will be known to those of ordinary skill in the art, RSN values are generally determined by titrating water into a solution of surfactant in 1,4 dioxane. The RSN values is generally defined as the amount of distilled water necessary to be added to produce persistent turbidity. In some embodiments the surfactant is an alkoxylated novolac resin (also known as a phenolic resin) with a relative solubility number in the range of 5-20. In some embodiments the surfactant is a block copolymer surfactant with a total molecular weight greater than 5000 daltons. The block copolymer may have a hydrophobic block that is comprised of a polymer chain that is linear, branched, hyperbranched, dendritic or cyclic.

In some embodiments, the surfactant is an aliphatic polyglycoside having the following formula:

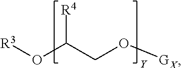

wherein R³ is an aliphatic group having from 6 to 18 carbon atoms; each R⁴ is independently selected from H, —CH₃, or —CH₂CH₃; Y is an average number of from about 0 to about 5; and X is an average degree of polymerization (DP) of from about 1 to about 4; G is the residue of a reducing saccharide, for example, a glucose residue. In some embodiments, Y is zero.

In some embodiments, the surfactant is an aliphatic glycamide having the following formula:

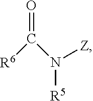

wherein R⁶ is an aliphatic group having from 6 to 18 carbon atoms; R⁵ is an alkyl group having from 1 to 6 carbon atoms; and Z is —CH₂(CH₂OH)_{b}CH₂OH, wherein b is from 3 to 5. In some embodiments, R⁵ is —CH₃. In some embodiments, R⁶ is an alkyl group having from 6 to 18 carbon atoms. In some embodiments, b is 3. In some embodiments, b is 4. In some embodiments, b is 5.

Suitable anionic surfactants include, but are not necessarily limited to, alkali metal alkyl sulfates, alkyl or alkylaryl sulfonates, linear or branched alkyl ether sulfates and sulfonates, alcohol polypropoxylated and/or polyethoxylated sulfates, alkyl or alkylaryl disulfonates, alkyl disulfates, alkyl sulphosuccinates, dialkyl sulphosuccinates alkyl ether sulfates, linear and branched ether sulfates, fatty carboxylates, alkyl sarcosinates, alkyl phosphates and combinations thereof.

In some embodiments, the surfactant is an aliphatic sulfate wherein the aliphatic moiety is a branched or linear, saturated or unsaturated aliphatic hydrocarbon moiety having from 6 to 18 carbon atoms. In some embodiments, the surfactant is an aliphatic sulfonate wherein the aliphatic moiety is a branched or linear, saturated or unsaturated aliphatic hydrocarbon moiety having from 6 to 18 carbon atoms.

In some embodiments, the surfactant is an aliphatic alkoxy sulfate wherein the aliphatic moiety is a branched or linear, saturated or unsaturated aliphatic hydrocarbon moiety having from 6 to 18 carbon atoms and from 4 to 40 total ethylene oxide (EO) and propylene oxide (PO) units.

In some embodiments, the surfactant is an aliphatic-aromatic sulfate wherein the aliphatic moiety is a branched or linear, saturated or unsaturated aliphatic hydrocarbon moiety having from 6 to 18 carbon atoms. In some embodiments, the surfactant is an aliphatic-aromatic sulfonate wherein the aliphatic moiety is a branched or linear, saturated or unsaturated aliphatic hydrocarbon moiety having from 6 to 18 carbon atoms.

In some embodiments, the surfactant is an ester or half ester of sulfosuccinic acid with monohydric alcohols.

In some embodiments, the surfactant is a quaternary alkylammonium salt or a quaternary alkylbenzylammonium salt, whose alkyl groups have 1 to 24 carbon atoms (e.g., a halide, sulfate, phosphate, acetate, or hydroxide salt). In some embodiments, the surfactant is a quaternary alkylbenzylammonium salt, whose alkyl groups have 1-24 carbon atoms (e.g., a halide, sulfate, phosphate, acetate, or hydroxide salt). In In some embodiments, the surfactant is an alkylpyridinium, an alkylimidazolinium, or an alkyloxazolinium salt whose alkyl chain has up to 18 carbons atoms (e.g., a halide, sulfate, phosphate, acetate, or hydroxide salt).

In some embodiments, the surfactant is a cationic surfactant such as, monoalkyl quaternary amines, such as cocotrimethylammonium chloride, cetyltrimethylammonium chloride, stearyltrimethylannnonium chloride, soyatrimethylannnonium chloride, behentrimethylammonium chloride, and the like and mixtures thereof. Other suitable cationic surfactants that may be useful include, but are not necessarily limited to, dialkylquaternary amines such as dicetyldimethylammonium chloride, dicocodimethylannnonium chloride, distearyldimethylammonium chloride, and the like and mixtures thereof.

In some embodiments, the surfactant is an amine oxide (e.g., dodecyldimethylamine oxide, lauramine oxide, laurylamidopropylamine oxide, cocamidopropylamine oxide). In some embodiments, the surfactant is amphoteric or zwitterionic, including sultaines (e.g., cocamidopropyl hydroxysultaine, lauryl sultaine, lauryl sulfobetaine, coco sultaine, coco sulfobetaine), betaines (e.g., cocamidopropyl betaine, lauramidopropyl betaine, or lauryl betaine, coco betaine), or phosphates (e.g., lecithin).

Non-limiting examples of suitable surfactants include nonionic surfactants with linear or branched structure, including, but not limited to, alkoxylated alcohols, alkoxylated fatty alcohols, alkoxylated castor oils, alkoxylated fatty acids, and alkoxylated fatty amides with a hydrocarbon chain of at least 8 carbon atoms and 5 units or more of alkoxylation. The term alkoxylation includes ethoxylation and propoxylation.

Other nonionic surfactants include alkyl glycosides and alkyl glucamides. Additional surfactants are described herein. Other non-limiting examples of surfactants include adsorption modifiers, foamers, surface tension lowering enhancers, and emulsion breaking additives. Specific examples of such surfactants include cationic surfactants with a medium chain length, linear or branched anionic surfactants, alkyl benzene anionic surfactants, amine oxides, amphoteric surfactants, silicone based surfactants, alkoxylated novolac resins (e.g. alkoxylated phenolic resins), alkoxylated polyimines, alkoxylated polyamines, and fluorosurfactants. In some embodiments, the surfactant is a nonionic surfactant. In certain embodiments, the nonionic surfactant may be one or more of an ethoxylated castor oil, an ethoxylated alcohol, an ethoxylated tristyrylphenol, or an ethoxylated sorbitan ester, or combinations thereof.

Co-Solvent

In some embodiments, an emulsion or microemulsion further comprises at least one co-solvent. The co-solvent may serve as a coupling agent between the one or more types of solvent and the surfactant and/or may aid in the stabilization of the emulsion or microemulsion. In some embodiments, the co-solvent is an alcohol. The alcohol may also be a freezing point depression agent for the emulsion or microemulsion. That is, the alcohol may lower the freezing point of the emulsion or microemulsion. In some embodiments, the alcohol is selected from primary, secondary, and tertiary alcohols having from 1 to 6 carbon atoms.

In some embodiments, the emulsion or microemulsion comprises a first type of co-solvent and second type of co-solvent. In some embodiments, the first type of co-solvent is a small chain alcohol (e.g., C₁₋₆ alcohol such as isopropanol). In some embodiments, the second type of co-solvent is an small chain alkylene glycol (e.g., C₁₋₇ alkylene glycol such as propylene glycol).

Non-limiting examples of co-solvents include methanol, ethanol, isopropanol, n-propanol, n-butanol, i-butanol, sec-butanol, iso-butanol, t-butanol, ethylene glycol, propylene glycol, dipropylene glycol monomethyl ether, triethylene glycol, and ethylene glycol monobutyl ether.

In some embodiments, the emulsion or microemulsion comprises from about 1 wt % to about 50 wt %, or from about 1 wt % to about 40 wt %, or from about 1 wt % to about 35 wt %, or from about 5 wt % to about 40 wt %, or from about 5 wt % to about 35 wt %, or from about 10 wt % to about 30 wt % of the co-solvent (e.g., alcohol), versus the total weight of the emulsion or microemulsion composition.

In some embodiments, the emulsion or microemulsion comprises from about 1 wt % and about 5 wt %, or from about 1 wt % and about 3 wt %, or about 2 wt % of the first type of co-solvent (e.g., C₁₋₆ alcohol such as isopropanol) and from about 15 wt % and about 25 wt %, or from about 17 wt % and about 22 wt % of the second type of co-solvent (e.g., C₁₋₇ alkylene glycol such as propylene glycol).

Other Additives

In some embodiments, the emulsion or microemulsion may comprise one or more additives in addition to the components discussed above. In some embodiments, the one or more additional additives are present in an amount from about 0 wt % to about 70 wt %, or from about 1 wt % to about 40 wt %, or from about 0 wt % to about 30 wt %, or from about 0.5 wt % to about 30 wt %, or from about 1 wt % to about 30 wt %, or from about 0 wt % to about 25 wt %, or from about 1 wt % to about 25 wt %, or from about 0 wt % to about 20 wt %, or from about 1 wt % to about 20 wt %, or from about 3 wt % to about 20 wt %, or from about 8 wt % to about 16 wt %, versus the total weight of the emulsion or microemulsion composition.

Non-limiting examples of additives include a demulsifier, a freezing point depression agent, a proppant, a scale inhibitor, a friction reducer, a biocide, a corrosion inhibitor, a buffer, a viscosifier, an oxygen scavenger, a clay control additive, a paraffin control additive, an asphaltene control additive, an acid, an acid precursor, or a salt.

In some embodiments, the additive is a demulsifier. The demulsifier may aid in preventing the formulation of an emulsion between a treatment fluid and crude oil. Non-limiting examples of demulsifiers include polyoxyethylene (50) sorbitol hexaoleate. In some embodiments, the demulsifier is present in the emulsion or microemulsion in an amount from about 4 wt % to about 8 wt % versus the total weight of the emulsion or microemulsion composition.

In some embodiments, the emulsion or the microemulsion comprises a freezing point depression agent (e.g., propylene glycol). The emulsion or the microemulsion may comprise a single freezing point depression agent or a combination of two or more freezing point depression agents. The term “freezing point depression agent” is given its ordinary meaning in the art and refers to a compound which is added to a solution to reduce the freezing point of the solution. That is, in some embodiments, a solution comprising the freezing point depression agent has a lower freezing point as compared to an essentially identical solution not comprising the freezing point depression agent. Those of ordinary skill in the art will be aware of suitable freezing point depression agents for use in the emulsions or the microemulsions described herein. Non-limiting examples of freezing point depression agents include primary, secondary, and tertiary alcohols with from 1 to 20 carbon atoms and alkylene glycols. In some embodiments, the alcohol comprises at least 2 carbon atoms. Non-limiting examples of alcohols include methanol, ethanol, i-propanol, n-propanol, t-butanol, n-butanol, n-pentanol, n-hexanol, and 2-ethyl hexanol. In some embodiments, the freezing point depression agent is not methanol (e.g., due to toxicity). Non-limiting examples of alkylene glycols include ethylene glycol (EG), polyethylene glycol (PEG), propylene glycol (PG), and triethylene glycol (TEG). In some embodiments, the freezing point depression agent is not ethylene oxide (e.g., due to toxicity). In some embodiments, the freezing point depression agent comprises an alcohol and an alkylene glycol. In some embodiments, the freezing point depression agent comprises a carboxycyclic acid salt and/or a di-carboxycylic acid salt. Another non-limiting example of a freezing point depression agent is a combination of choline chloride and urea. In some embodiments, the emulsion or microemulsion comprising the freezing point depression agent is stable over a wide range of temperatures, e.g., from about 50° F. to 200° F. In some embodiments a freezing point depression agent is present in the emulsion or microemulsion in an amount from about 10 wt % to about 15 wt %.

In some embodiments, the emulsion or the microemulsion comprises a proppant. In some embodiments, the proppant acts to hold induced hydraulic fractures open in an oil and/or gas well. Non-limiting examples of proppants (e.g., propping agents) include grains of sand, glass beads, crystalline silica (e.g., quartz), hexamethylenetetramine, ceramic proppants (e.g., calcined clays), resin coated sands, and resin coated ceramic proppants. Other proppants are also possible and will be known to those skilled in the art.

In some embodiments, the emulsion or the microemulsion comprises a scale inhibitor. The scale inhibitor may slow scaling in, e.g., the treatment of an oil and/or gas well, wherein scaling involves the unwanted deposition of solids (e.g., along a pipeline) that hinders fluid flow. Non-limiting examples of scale inhibitors include one or more of methyl alcohol, organic phosphonic acid salts (e.g., phosphonate salt, aminopolycarboxlic acid salts), polyacrylate, ethane-1,2-diol, calcium chloride, and sodium hydroxide. Other scale inhibitors are also possible and will be known to those skilled in the art.

In some embodiments, the emulsion or the microemulsion comprises a friction reducer. The friction reducer may reduce drag, which reduces energy input required in the context of e.g. delivering the emulsion or microemulsion into a wellbore. Non-limiting examples of friction reducers include oil-external emulsions of polymers with oil-based solvents and an emulsion-stabilizing surfactant. The emulsions may include natural-based polymers like guar, cellulose, xanthan, proteins, polypeptides or derivatives of same or synthetic polymers like polyacrylamide-co-acrylic acid (PAM-AA), polyethylene oxide, polyacrylic acid, and other copolymers of acrylamide and other vinyl monomers. For a list of non-limiting examples, see U.S. Pat. No. 8,865,632, filed Nov. 10, 2008, entitled “DRAG-REDUCING COPOLYMER COMPOSITION,” herein incorporated by reference. Other common drag-reducing additives include dispersions of natural- or synthetic polymers and copolymers in saline solution and dry natural- or synthetic polymers and copolymers. These polymers or copolymers may be nonionic, zwitterionic, anionic, or cationic depending on the composition of polymer and pH of solution. Other non-limiting examples of friction reducers include petroleum distillates, ammonium salts, polyethoxylated alcohol surfactants, and anionic polyacrylamide copolymers. Other friction reducers are also possible and will be known to those skilled in the art.

In some embodiments, the emulsion or the microemulsion comprises a biocide. The biocide may kill unwanted organisms (e.g., microorganisms) that come into contact with the emulsion or microemulsion. Non-limiting examples of biocides include didecyl dimethyl ammonium chloride, gluteral, Dazomet, bronopol, tributyl tetradecyl phosphonium chloride, tetrakis (hydroxymethyl) phosphonium sulfate, AQUCAR®, UCARCIDE®, glutaraldehyde, sodium hypochlorite, and sodium hydroxide. Other biocides are also possible and will be known to those skilled in the art.

In some embodiments, the emulsion or the microemulsion comprises a corrosion inhibitor. The corrosion inhibitor may reduce corrosion during e.g. treatment of an oil and/or gas well (e.g., in a metal pipeline). Non-limiting examples of corrosion inhibitors include isopropanol, quaternary ammonium compounds, thiourea/formaldehyde copolymers, propargyl alcohol, and methanol. Other corrosion inhibitors are also possible and will be known to those skilled in the art.

In some embodiments, the emulsion or the microemulsion comprises a buffer. The buffer may maintain the pH and/or reduce changes in the pH of the aqueous phase of the emulsion or the microemulsion. Non-limiting examples of buffers include acetic acid, acetic anhydride, potassium hydroxide, sodium hydroxide, and sodium acetate. Other buffers are also possible and will be known to those skilled in the art.

In some embodiments, the emulsion or the microemulsion comprises a viscosifier. The viscosifier may increase the viscosity of the emulsion or the microemulsion. Non-limiting examples of viscosifiers include polymers, e.g., guar, cellulose, xanthan, proteins, polypeptides or derivatives of same or synthetic polymers like polyacrylamide-co-acrylic acid (PAM-AA), polyethylene oxide, polyacrylic acid, and other copolymers of acrylamide and other vinyl monomers. Other viscosifiers are also possible and will be known to those skilled in the art.

In some embodiments, the emulsion or the microemulsion comprises an oxygen scavenger. The oxygen scavenger may decrease the level of oxygen in the emulsion or the microemulsion. Non-limiting examples of oxygen scavengers include sulfites and bisulfites. Other oxygen scavengers are also possible and will be known to those skilled in the art.

In some embodiments, the emulsion or the microemulsion comprises a clay control additive. The clay control additive may minimize damaging effects of clay (e.g., swelling, migration), e.g., during treatment of oil and/or gas wells. Non-limiting examples of clay control additives include quaternary ammonium chloride, tetramethylammonium chloride, polymers (e.g., polyanionic cellulose (PAC), partially hydrolyzed polyacrylamide (PHPA), etc.), glycols, sulfonated asphalt, lignite, sodium silicate, and choline chloride. Other clay control additives are also possible and will be known to those skilled in the art.

In some embodiments, the emulsion or the microemulsion comprises a paraffin control additive and/or an asphaltene control additive. The paraffin control additive or the asphaltene control additive may minimize paraffin deposition or asphaltene precipitation respectively in crude oil, e.g., during treatment of oil and/or gas wells. Non-limiting examples of paraffin control additives and asphaltene control additives include active acidic copolymers, active alkylated polyester, active alkylated polyester amides, active alkylated polyester imides, aromatic naphthas, and active amine sulfonates. Other paraffin control additives and asphaltene control additives are also possible and will be known to those skilled in the art.

In some embodiments, the emulsion or the microemulsion comprises an acid and/or an acid precursor (e.g., an ester). For example, the emulsion or the microemulsion may comprise an acid when used during acidizing operations. In some embodiments, the surfactant is alkaline and an acid (e.g., hydrochloric acid) may be used to adjust the pH of the emulsion or the microemulsion towards neutral. Non-limiting examples of acids or di-acids include hydrochloric acid, acetic acid, formic acid, succinic acid, maleic acid, malic acid, lactic acid, and hydrochloric-hydrofluoric acids. In some embodiments, the emulsion or the microemulsion comprises an organic acid or organic di-acid in the ester (or di-ester) form, whereby the ester (or diester) is hydrolyzed in the wellbore and/or reservoir to form the parent organic acid and an alcohol in the wellbore and/or reservoir. Non-limiting examples of esters or di-esters include isomers of methyl formate, ethyl formate, ethylene glycol diformate, alpha,alpha-4-trimethyl-3-cyclohexene-1-methylformate, methyl lactate, ethyl lactate, alpha,alpha-4-trimethyl 3-cyclohexene-1-methyllactate, ethylene glycol dilactate, ethylene glycol diacetate, methyl acetate, ethyl acetate, alpha,alpha,-4-trimethyl-3-cyclohexene-1-methylacetate, dimethyl succinate, dimethyl maleate, di(alpha,alpha-4-trimethyl-3-cyclohexene-1-methyl)-succinate, 1-methyl-4-(1-methylethenyl)-cyclohexylformate, 1-methyl-4-(1-ethylethenyl)-cyclohexylactate, 1-methyl-4-(1-methylethenyl)-cyclohexylacetate, and di(1-methy-4-(1-methylethenyl)cyclohexyl)-succinate. Other acids are also possible and will be known to those skilled in the art.

In some embodiments, the emulsion or the microemulsion comprises a salt. The salt may reduce the amount of water needed as a carrier fluid and/or may lower the freezing point of the emulsion or the microemulsion. Non limiting examples of salts include salts comprising K, Na, Br, Cr, Cs, or Li, e.g., halides of these metals, including but not limited to NaCl, KCl, CaCl₂, and MgCl₂. Other salts are also possible and will be known to those skilled in the art.

In some embodiments, the emulsion or the microemulsion comprises an additive as described in U.S. patent application Ser. No. 15/457,792, filed Mar. 13, 2017, entitled “METHODS AND COMPOSITIONS INCORPORATING ALKYL POLYGLYCOSIDE SURFACTANT FOR USE IN OIL AND/OR GAS WELLS,” published as US 2017-0275518 on Sep. 28, 2017, herein incorporated by reference.

Since dispersion polymers were developed in such a way as deliberately not containing solvents, surfactants, or microemulsions, it would not be obvious to create a drag-reducing additive comprising a dispersion polymer with a solvent, a surfactant, a microemulsion, and/or combinations therefore. The anticipated level of friction reduction or drag reduction performance obtained with such drag-reducing additives, would not be obvious to a person skilled in the art without appropriate experimentation. A person skilled in the art would know what levels of friction reduction and what dose of a friction reducer are economically justified for a given oil and/or gas well, and based on that knowledge, would make a decision on the suitability of a given drag-reducing additive. Further, a person of ordinary skilled in the art would know which specific solvents, surfactants, and microemulsions can be used for blending with dispersion polymers.

When combining dispersion polymers with solvents, surfactants, microemulsions, or combinations thereof, it is desirable to achieve homogeneous composition blend, which may be pumped or injected down a subterranean formation, such as an oil or gas well. Certain blends of the dispersion polymer with solvents, surfactants, microemulsions, or combinations thereof, may be more viscous than other blends, and may even be paste-like. These paste-like compositions may be undesirable, but may still be used within the scope of the present invention. In addition, in some embodiments, the solvent may separate out from the dispersion polymer composition on standing, forming a heterogeneous mixture. To obtain a homogenous composition that may be pumped or injected, the solvent may be blended by mixing it with the dispersion polymer composition prior to pumping or injecting.

In some embodiments of the drag-reducing additive, the additive is a homogenous mixture. A mixture is homogenous if it has a uniform composition and contains the same properties throughout the mixture. In other embodiments of the drag-reducing additive, when the amount of the surfactant is insufficient, then the drag-reducing additive may exhibit some degree of separation of the solvent, producing a heterogeneous mixture (e.g. not homogenous). Generally, the surfactant is necessary in the drag-reducing additive in order to create a homogenous mixture of dispersion polymer and solvent. It is recognized that the term “homogeneous” is always referenced to a particular time or length scale. The system appearing as homogeneous on one length or time scale may not necessarily be homogeneous on another length or time scale.

The present invention may provide numerous advantage and benefits. One such benefit is reduction in the amount of equipment (e.g. pumps, transportation vehicles, storage space) and electrical power requirements necessary at the wellsite. Ordinarily, there would be at least one pump and related equipment associated with pumping additive such as solvents, surfactants, microemulsions, or combinations thereof, down the well. In addition, there would be at least a separate, second pump and related equipment associated with pumping drag-reducing additives down the well. However, with the present invention, it is possible to eliminate additional pumps and associated equipment and electrical power requirements, because the dispersion polymer is combined with the solvents, surfactants, microemulsions, or combinations thereof, when it is pumped simultaneously in one step using one pump. By pumping in one step, costs of electricity associated with the need to run multiple pumping equipment units are significantly reduced. In addition, using the inventive drag-reducing additive provides the benefit of saving time needed to treat the well.

There are several methods of preparing or making various drag-reducing additives comprising dispersion polymers and other additives (e.g. solvents, surfactants, microemulsions, and/or combinations thereof). Non-limiting examples of dispersion polymers comprise anionic dispersion polymers, cationic dispersion polymers, and amphoteric dispersion polymers, each of which is commercially available. Once the drag-reducing additives are prepared, the drag-reducing additives may be combined with an aqueous treatment fluid (e.g. fracturing fluid, water, and/or brine) to form a drag-reducing composition, which is useful in the treatment of a subterranean formation (e.g. oil and/or gas well), a pipeline, or a gathering line.

In a preferred embodiment of making the drag-reducing additive, a solvent and a surfactant are first blended together to form a solvent-surfactant blend. Next, the solvent-surfactant blend is added to a dispersion polymer, which comprises an aqueous phase, to create a drag-reducing additive. In some embodiments, when the solvent-surfactant blend is mixed with the dispersion polymer, a portion of the aqueous phase of the dispersion polymer may form an emulsion or a microemulsion with the solvent and surfactant. After that step, the drag-reducing additive may be combined with an aqueous treatment fluid (e.g. fracturing fluid, water, and/or brine) to form a drag-reducing composition. The drag-reducing composition may then be injected in a subterranean formation (e.g. the oil and/or gas well), a pipeline, or a gathering line where friction reduction is desired.

In another embodiment of making the drag-reducing additive, a solvent is first added to the dispersion polymer, which comprises an aqueous phase, to form a solvent-dispersion polymer blend. Next, the solvent-dispersion polymer blend is added to a surfactant to create the drag-reducing additive. In some embodiments, when the solvent-dispersion polymer blend is mixed with the surfactant, a portion of the aqueous phase of the dispersion polymer may form an emulsion or a microemulsion with the solvent and surfactant. After that step, the drag-reducing additive may be combined with an aqueous treatment fluid (e.g. fracturing fluid, water, and/or brine) to form a drag-reducing composition. The drag-reducing composition may then be injected in a subterranean formation (e.g. the oil and/or gas well), a pipeline, or a gathering line where friction reduction is desired.

In another embodiment of making the drag-reducing additive, a surfactant is first added to the dispersion polymer, which comprises an aqueous phase, to form a surfactant-dispersion polymer blend. Next, the surfactant-dispersion polymer blend is added to a solvent to create the drag-reducing additive. In some embodiments, when the surfactant-dispersion polymer blend is mixed with the solvent, a portion of the aqueous phase of the dispersion polymer may form an emulsion or a microemulsion with the solvent and surfactant. After that step, the drag-reducing additive may be combined with an aqueous treatment fluid (e.g. fracturing fluid, water, and/or brine) to form a drag-reducing composition. The drag-reducing composition may then be injected in a subterranean formation (e.g. the oil and/or gas well), a pipeline, or a gathering line where friction reduction is desired.

In another embodiment of making the drag-reducing additive, a microemulsion comprising a solvent, a surfactant, and water is created or obtained from commercially available sources. Next, the microemulsion is added to a dispersion polymer to create the drag-reducing additive. After that step, the drag-reducing additive may be combined with an aqueous treatment fluid (e.g. fracturing fluid, water, and/or brine) to form a drag-reducing composition. The drag-reducing composition may then be injected in a subterranean formation (e.g. the oil and/or gas well), a pipeline, or a gathering line where friction reduction is desired. In some embodiments, the dispersion polymer is present from about 70 wt % to about 99 wt % versus the total weight of the drag-reducing additive. In some embodiments, the dispersion polymer is present from about 85 wt % to about 95 wt % versus the total weight of the drag-reducing additive. In some embodiments, the microemulsion is present from about 0.5 wt % to about 30 wt % versus the total weight of the drag-reducing additive. In some embodiments, the microemulsion is present from about 5 wt % to about 15 wt % versus the total weight of the drag-reducing additive.

Dry (powder) polymers may be used as part of the drag-reducing additive if they are first dissolved in a treatment fluid miscible with water or as a dispersion. Other polymers such as guar, xanthan, and other natural polymers along with synthetics can also be used as part of the drag-reducing additive.

When combined, the copolymer, solvent, and surfactant become a one-phase system that may remain stable for more than 24 hours and may be adapted for use in a broad temperature range. Thus, each of the selected components in the drag-reducing additive may be mixed together before delivery to the well.

A two-component embodiment of the drag-reducing additive is preferably made by combining about 50-99% of a polymer emulsion with about 1-50% of a surfactant with an HLB above about 7. Having more than 50% surfactant may also yield suitable friction reducing formulations, but such systems may be unstable, not as effective and efficient in friction reduction, and not as cost-advantageous, as systems with less than 50% surfactant. The two-component additive becomes highly viscous when about 75-99% of the polymer emulsion is combined with about 1-25% of the surfactant. Addition of less than 5% of a solvent may result in producing high viscosity embodiment of the additive. Addition of a small amount of solvent may actually increase the viscosity of the additive, but upon addition of larger amounts of solvent, the viscosity will be decreased. In another embodiment, less than about 30% of the polymer emulsion is combined with about 70-99% of the surfactant with an HLB of above about 7. In a preferred embodiment, the two-component additive may be made by using a commercially available polymer emulsion, and the surfactant with an HLB of greater than about 7, and most preferably with an HLB of about 12 to about 13. The highly viscous form of the two-component additive may be delivered to a solution by a pump, extruding device or any other suitable means. The highly viscous form of the two-component additive may generally have a complex viscosity magnitude of greater than about 40 Pascal-sec (Pa s).

The additives described above have multiple uses. The uses may include, without limitation, drag reduction, flocculation, water clarification, solids/liquids separation, sludge dewatering, mining, and papermaking.

More specifically, compositions described above may be suitable as flocculation-promoting agents in solids-liquid separation, water treatment, papermaking, mining, and other applications. They can be used alone, or in a combination with various other additives typically used to promote flocculation. These other additives include but are not limited to high molecular weight polymers bearing anionic and cationic charge or no charge at all. Some non-limiting examples of such polymers include various copolymers of polyacrylamide, cross-linked, linear or branched, as well as polyethylene oxide and poly naphthalene sulfonate. Other known additives in the flocculation process that can be used in combination with the compositions of the present invention include chemically modified and unmodified polysaccharides, such as starches, coagulants, such as aluminum sulfate, poly aluminium chloride, poly-diallyl dimethyl ammonium chloride (DADMAC), poly-epichlorohydrine dimethyl ammonium chloride, 3-trimethylammonium propyl methacrylamide chloride (MAPTAC), or other similar substances. Other suitable additives can be chosen from a class of colloidal materials, such as colloidal silica, colloidal borosilicate, colloidal zirconium oxide, colloidal aluminum oxide and hydroxide, colloidal alumosilicate, or clays, both naturally occurring and synthetic, such as bentonite, laponite, saponite. Microgels, such as polysilicate microgel and polyalumosilicate microgel, are also suitable colloidal products. Structurally rigid polymers and polymer microbeads also may be used in combination with compositions of the present invention.

At the well site or in the pipelines or gathering lines, the drag-reducing additive is added to a water-based treatment fluid to be pumped downhole or through the piping system. In a preferred embodiment, the drag-reducing additive comprises about 0.05 to 2 gallons of solution per 1000 gallons of water (gpt). In another preferred embodiment, the drag-reducing additive comprises about 0.05 to 4 gpt.

In a presently preferred embodiment, the drag-reducing additive is delivered downhole or into a pipeline or gathering line by continuously adding it to the water-based treatment fluid as the treatment fluid is pumped, at rates of 0.05 to 5 gallons drag-reducing additive per 1000 gallons fracturing fluid. The drag-reducing additive is preferably added to the treatment fluid at or near the blending device and before the high pressure pumps in a fracturing treatment. In a friction-reducing application, the emulsion inverts rapidly as the fracturing fluid proceeds down the tubulars, allowing the copolymer solution to solubilize in the aqueous phase. The drag-reducing additive suppresses turbulence and lowers the necessary pumping pressure.

The following examples describe tests performed on various embodiments of the drag-reducing additive, as well as prior art drag-reducing systems. It will be understood that these examples are merely illustrative and are not to be considered limiting.

Testing

Friction loop devices to evaluate friction/drag reduction are known in the art. The device used to for the following tests consists of a 15 gallon tank from which fluid is pumped at a maximum flow rate of 12 gallons per minute (gpm) through a series of pipes. The first pipe is 10 feet long with a 0.75 inch outer diameter (OD) and a 0.62 inch inner diameter (ID). The first pipe is connected to a 25 foot long, 0.50 inch OD, 0.40 inch ID stainless steel test pipe. Differential pressure is measured by means of pressure transducers across a 10 foot section of the test pipe called the “Test Section.” The Test Section begins at a point 10 feet along the test pipe. After the fluid flows through the Test Section, it is looped back into the pump. The output of the differential pressure measurements is registered by a computer running LabVIEW® automation software available from the National Instruments Corporation. It will be understood that other methods of testing drag reduction may be used.

In a typical experiment, a 15 gallon reservoir is filled with 8 gallons of base fluid comprising either tap water or brine, which will provide a baseline and to verify proper operation of the flow loop. The base fluid can also be a produced water from a well or other process water. One suitable brine consists of 7% by weight potassium chloride solution. The base fluid is recirculated for 2 minutes at a flow rate of 10 gpm, the baseline point is recorded, and the flow loop is then stopped. The drag-reducing additive or prior art drag reducer is then injected using a 60 ml syringe at doses between 0.05 to 2 gpt. The fluid is then recirculated in the loop. The flow rate initially is set at 12 gpm and then ramped down to 2 gpm in 2 gpm increments. At each flow rate, the fluid is recirculated for 60 seconds. After 2 gpm flow rate has been reached, the flow rate is ramped back to 12 gpm in 2 gpm increments. This part of the test is referred to as “ramping.” After the last 12 gpm setting is reached, the flow rate is reduced to 10 gpm and the liquid is allowed to further recirculate in the loop for 10 minutes. This part of the experiment is referred to as “recirculation.” During recirculation, differential pressure is measured at the beginning (t=0) and at the end (t=10 min) of the process. Performing the drag reduction experiment in such way allows one to simulate situations of changing flow rate gradients typically encountered in the oilfield, such as in performing hydraulic fracturing jobs. The percent friction reduction (% FR) is calculated at each flow rate as follows:

$$\% FR = \frac{{DP}_{BL} - {DP}_{S}}{{DP}_{BL}} \times 100 \%$$

where DP_{BL} and DP_{S} are the differential pressures obtained without and with drag-reducing system, respectively. The value of DP_{BL} represents 100% friction baseline for water or brine.

At each flow rate, the value of DP_{BL} is calculated using the following set of equations:

$$Δ {P}_{BL} = \frac{L \times v \times ρ \times f}{25.8 \times D}$$

$$v = \frac{Q}{2.45 \times {D}^{2}}$$

$$f = \frac{0.3164}{4} \times {Re}^{0.25}$$

$$Re = \frac{928 \times D \times v \times ρ}{μ}$$

where L is the length of the test section measured in inches, v is fluid velocity in ft/sec, ρ is the fluid density in lb/gal, D is the internal diameter of the pipe measured in inches, Q is volumetric flow in gals/min, f is the Fanning friction factor, Re is Reynolds number, and μ is dynamic viscosity of the liquid in cP. The units for differential pressures are psi.

Core Permeability Testing

The impact of samples on core permeability was evaluated with a Formation Response Tester (FRT) using the following method. First, a 2 inch long, 1 inch diameter section is cut out of an Ohio sandstone core with a permeability around 1 milliDarcy (mD) using a lapidary trim saw. The cut core is then washed with water and dried overnight at 230° F. The wash water is preferably around 2.0% KCl so as to not damage clays that may be present in the core. Diameter and length of the core are measured with a caliper. The core is then de-aerated under vacuum at 28-30 inches of mercury (in Hg) for 2 hours and saturated with 7% KCl brine overnight. The saturated core is then placed in the core holder chamber of the FRT instrument, at room temperature. The core chamber is subjected to 1500 psi confining pressure and 500 psi back pressure. Permeability of the core is measured in production this permeability is taken as the initial permeability value, Kᵢ. After production flow has been stopped, 1 gallon of 0.166 volume % solution of the drag-reducing additive in 7% KCl brine is flowed across the end of the core at a flow rate of 0.8 L/min for 30 minutes under the applied 100 psi pressure gradient. After the solution containing the drag-reducing additive has been pumped for 30 minutes, the core is again flooded in production direction using the same conditions as used in determining initial permeability. Final permeability of the core, K_{f}, is determined. The percentage of permeability regained due to the use of the samples is then calculated as

$$\frac{{K}_{f}}{{K}_{j}} \times 100 \% .$$

Rheology Measurements

Rheological measurements were performed to characterize materials of the present invention using the AR-G2 rheometer with 40 mm 2° cone-and-plate geometry from TA Instruments®. In a typical experiment a sinusoidal oscillating strain was applied to a sample at a frequency of 1 Hz (ω=6.283 radians per s), and stress varied between 0.05 and 150 Pa. Details of rheological measurements and meaning of principal rheological parameters are known to those skilled in the art. Materials of the present invention, as well as the emulsion polymers of the prior art, can be characterized by a combination of elastic (G′) and viscous (G″) modulus. The magnitude of complex viscosity, η*, can be calculated as

$$\vert {η}^{*} \vert = {[ {( \frac{{G}^{″}}{ω} )}^{2} + {( \frac{{G}^{′}}{ω} )}^{2} ]}^{1 \text{/} 2}$$

The value of the complex viscosity determines how easy or difficult it is for one to use the drag-reducing additive, including blending it with other fluids (e.g. aqueous carrier fluid) to create a drag-reducing composition. For ease of using the drag-reducing additive, the preferred value for the complex viscosity of the drag reduction additive is less than or equal to 40 Pa s. However, drag-reducing additives with a complex viscosity that are greater than 40 Pa s can still be used to obtain drag reduction benefits, provided that the proper equipment and methods are used to deliver the drag-reducing additive or drag-reducing composition down the well.

### Example 1

In a beaker, 22.5 grams of an ethoxylated castor oil surfactant such as Stepantex® CO-30, available from Stepan® Corporation, are mixed with 17.5 grams of d-limonene. The mixture is stirred until clear amber-colored solution is obtained. To this mixture is added 60 grams of the polymer described in Samples 1-1 through 1-3 below. The resulting mixture is then stirred at 300 rpm until a homogeneous, flowable formulation is obtained. Friction reducing performance and effect on core permeability are then evaluated as described above. Within the teachings of this example, the following samples were prepared:

Sample 1-1: Drag-reducing additive in which the polymer is the anionic copolymer emulsion of acrylamide sodium acrylate, such as Hychem AE853, available from Hychem, Inc. This sample had an elastic modulus G′=9.6 Pa, viscous modulus G″=8.8 Pa, complex viscosity of 2.1 Pa s, and did flow easily. Both of these values were much lower than the corresponding values established for AE853 polymer, which had G′=237.4 Pa, G″=70 Pa, and |η*|=39.4 Pa s.

Sample 1-2: Drag-reducing additive in which the polymer is a nonionic polyacrylamide emulsion. In a preferred embodiment, the polymer is Hychem NE823, available from Hychem, Inc.

Sample 1-3: Drag-reducing additive in which the polymer is a cationic copolymer emulsion of acrylamide and dimethylaminoethylacrylate methyl chloride quarternary salt (DMAEA MCQ), such as Hychem CE335, available from Hychem, Inc.

Table 1 summarizes the drag reduction performance of Samples 1-1 through 1-3, as well as the performance of constituent conventional polymer emulsions used alone. The dosing of both the Samples and the conventional polymer emulsions is 1 gpt of the conventional polymer emulsion.

TABLE 1
Drag reduction performance of Samples 1-1 through 1-3 and performance
of constituent conventional polymer emulsions used alone.

| | | % Friction | % Friction |
|---|---|---|---|
| | | Reduction in | Reduction in 7% |
| Sample | Flow rate (gpm) | Water (%) | KCl Brine (%) |
| Sample 1-1 | Ramping | | |
| | 12 | 77 | 77 |
| | 6 | 71 | 72 |
| | 12 | 77 | 77 |
| | Recirculation | | |
| | 10 (t = 0 min) | 76 | 74 |
| | 10 (t = 10 min) | 76 | 76 |
| Sample 1-2 | Ramping | | |
| | 12 | 78 | 77 |
| | 6 | 55 | 68 |
| | 12 | 61 | 67 |
| | Recirculation | | |
| | 10 (t = 0 min) | 55 | 61 |
| | 10 (t = 10 min) | 48 | 54 |
| Sample 1-3 | Ramping | | |
| | 12 | 77 | 79 |
| | 6 | 72 | 74 |
| | 12 | 78 | 77 |
| | Recirculation | | |
| | 10 (t = 1 min) | 77 | 75 |
| | 10 (t = 10 min) | 77 | 69 |
| AE853 | Ramping | | |
| | 12 | 75 | 70 |
| | 6 | 69 | 60 |
| | 12 | 75 | 66 |
| | Recirculation | | |
| | 10 (t = 0 min) | 76 | 64 |
| | 10 (t = 10 min) | 76 | 62 |
| NE823 | Ramping | | |
| | 12 | 78 | 77 |
| | 6 | 63 | 52 |
| | 12 | 64 | 62 |
| | Recirculation | | |
| | 10 (t = 0 min) | 58 | 57 |
| | 10 (t = 10 min) | 50 | 51 |
| CE335 | Ramping | | |
| | 12 | 78 | 62 |
| | 6 | 73 | 64 |
| | 12 | 79 | 75 |
| | Recirculation | | |
| | 10 (t = 0 min) | 77 | 72 |
| | 10 (t = 10 min) | 77 | 60 |

Table 1 illustrates that although all Samples are effective drag reducers, some are more preferable than others. As such, microemulsified polymer systems made with anionic polymers are preferred over those made with a nonionic or cationic polymers. Table 1 also illustrates the benefit of using the Samples over conventional polymers. Table 1 indicates a rapid decrease in the percent friction reduction achieved with conventional drag-reducing polymer emulsions upon transition from water to 7% KCl brine, while this is not the case with the Samples. Also, under equivalent conditions, the Samples yielded consistently higher values of friction reduction than the corresponding polymer emulsions alone. The data in Table 1 also indicates that in brine, cationic drag-reducing polymer Hychem CE335 had to be recirculated in the loop for a substantial period of time until the optimum drag reduction of 75% was achieved, while the system of the present invention based on the same polymer achieved this high level of drag reduction immediately.

### Example 2

In a beaker, 20 grams of ethoxylated castor oil are mixed with 20 grams of terpene. The mixture is stirred until clear amber-colored solution is obtained. To this mixture is added 60 grams of the copolymer described in Sample 2-1, 2-2, or 2-3 below. The resulting mixture is then stirred at 300 rpm until a homogeneous, flowable formulation is obtained. Friction reducing performance and effect on core permeability are then evaluated as described above. Within the teachings of this example, the following samples were prepared:

Sample 2-1: A copolymer emulsion of acrylamide and sodium acrylate is combined with ethoxylated castor oil surfactant and peppermint oil terpenes according to the procedure in Example 2 above. In a preferred embodiment, the copolymer emulsion is Hychem AE853, available from Hychem, Inc., and the ethoxylated castor oil surfactant is Stepantex® CO-30, available from Stepan® Corporation. The peppermint oil terpene is available from GreenTerpene.com.

Sample 2-2: A copolymer emulsion of acrylamide and sodium acrylate is combined with ethoxylated castor oil surfactant and eucalyptus oil terpenes according to the procedure in Example 2 above. In a preferred embodiment, the copolymer emulsion is Hychem AE853, available from Hychem, Inc., and the ethoxylated castor oil surfactant is Stepantex® CO-30, available from Stepan® Corporation. The eucalyptus oil terpene is available from GreenTerpene.com.

Sample 2-3: A copolymer emulsion of and sodium acrylate is combined with a sorbitan monooleate surfactant and a terpene comprising d-limonene according to the procedure in Example 2 above. In a preferred embodiment, the copolymer emulsion is Hychem AE853, available from Hychem, Inc., and the surfactant is TWEEN 80. The d-limonene is available from Florida Chemical® Company, LLC.

Drag reduction performance of Samples 2-1 through 2-3 in 7% KCl brine is summarized in Table 2. The dosing of both the Samples and the conventional polymer emulsions is 1 gpt of the conventional polymer emulsion.

TABLE 2
Drag reduction performance of Samples
2-1 through 2-3 in 7% KCl brine

| | | % Friction |
|---|---|---|
| | | Reduction in 7% |
| Sample | Flow rate (gpm) | KCl Brine (%) |
| Sample 2-1 | Ramping | |
| | 12 | 77 |
| | 6 | 73 |
| | 12 | 77 |
| | Recirculation | |
| | 10 (t = 0 min) | 75 |
| | 10 (t = 10 min) | 74 |
| Sample 2-2 | Ramping | |
| | 12 | 77 |
| | 6 | 73 |
| | 12 | 77 |
| | Recirculation | |
| | 10 (t = 0 min) | 76 |
| | 10 (t = 10 min) | 74 |
| Sample 2-3 | Ramping | |
| | 12 | 77 |
| | 6 | 72 |
| | 12 | 77 |
| | Recirculation | |
| | 10 (t = 0 min) | 75 |
| | 10 (t = 10 min) | 74 |

Table 2 shows that Samples 2-1 through 2-3 caused a reduction in friction by more than 70% and were superior to drag-reducing polymer AE853 used alone (Table 1).

The results of core permeability evaluation with systems of the invention indicated that samples from both Table 1 and Table 2 yielded regained permeability of greater than 74%. Sample 1-1, which is a particularly preferred embodiment, yielded regained permeability of 97%.

### Example 3

To 27.3 g of ethoxylated castor oil surfactant (Stepantex® CO-30), 72.7 g of Hychem AE853 copolymer emulsion was added, and the mixture was stirred to form Sample 3. Formulation of a paste-like, highly viscous material was observed. The paste was loaded into a syringe and extruded into the base liquid to achieve a dose of 1 gpt based on polymer actives. This sample had an elastic modulus G′=234 Pa, viscous modulus G″=87 Pa, and complex viscosity |η*|=42 Pa s. This material was much less flowable than both material of example 1-1 and prior art friction reducer Hychem AE853, as indicated by significantly higher values of G′ and |η*|.

TABLE 3
Drag reduction performance of Sample 3 in 7% KCl Brine

| | | % Friction |
|---|---|---|
| | | Reduction in 7% |
| Sample | Flow rate (gpm) | KCl Brine |
| Sample 3 | Ramping | |
| | 12 | 76 |
| | 6 | 71 |
| | 12 | 76 |
| | Recirculation | |
| | 10 (t = 0 min) | 75 |
| | 10(t = 10 min) | 75 |

The compositions of the present invention can be used for aiding in the recovery of crude oil and natural gas from subterranean formations. It is possible to use these compositions by a variety of means. For example, in one suitable embodiment, compositions of the present invention may be delivered to the use site as a single formulation. To make such formulation, it is possible to mix the components in any order. In the other suitable unlimited embodiment, the individual components making compositions of this invention can be mixed “on the fly”. Other means of using the systems of this invention may include, but are not limited to pre-dissolving one or more components in the treatment fluid or pre-blending two or more components prior to the addition of a third one. In preferred embodiments, acceptable treatment ranges may include adding from about 0.01 gallons to 50 gallons of drag-reducing additive per 1,000 gallons of the aqueous treatment fluid.

### Example 4

In a 140 ml jar, 2.5 g of ethoxylated castor oil surfactant and 17.5 g of d-limonene solvent were mixed together. The mixture was stirred with a cage stirrer mixer at 735 rpm for about 15 s and then 30 g of an anionic dispersion polymer was added into stirred mixture. This composition comprises 5% ethoxylated castor oil surfactant, 35% d-limonene solvent, and 60% anionic dispersion polymer. Stirring continued for about 5 minutes. The friction reduction performance of the mixture was evaluated in a friction flow loop in 7% KCl brine at a dose of 0.83 gallons per 1000 gallons (gpt) of brine at a flow rate of 10 gal/min.

### Example 5

In a 140 ml jar, 5 g of ethoxylated castor oil surfactant and 15 g of d-limonene were mixed together. The mixture was stirred with a cage stirrer mixer at 735 rpm for about 15 s and 30.3 g of an anionic dispersion polymer was added into stirred mixture. This composition comprises 9.94% ethoxylated castor oil surfactant, 29.82% d-limonene solvent, and 60.24% anionic dispersion polymer. Stirring continued for about 5 minutes. The friction reduction performance of the mixture was evaluated in a friction flow loop in 7% KCl brine at a dose of 0.83 gallons per 1000 gallons (gpt) of brine at a flow rate of 10 gal/min.

### Example 6

In a 140 ml jar, 29.8 g of an anionic dispersion polymer and 17.5 g of d-limonene solvent were mixed together. Two layers were observed, indicating a heterogeneous mixture. The mixture was then stirred with a cage stirrer mixer at 735 rpm. To this mixture, 2.5 g of ethoxylated castor oil surfactant was then added. This composition comprises 5% ethoxylated castor oil surfactant, 35% d-limonene solvent, and 60% anionic dispersion polymer. Upon the addition of the ethoxylated castor oil surfactant, a homogeneous, opaque mixture was obtained. The friction reduction performance of the mixture was evaluated in a friction flow loop in 7% KCl brine at a dose of 0.83 gallons per 1000 gallons (gpt) of brine at a flow rate of 10 gal/min.

TABLE 4
Drag reduction performance at equal polymer concentration
of compositions comprising drag-reducing additives
of Examples 4-6 in 7% KCl brine

| | Maximum | % Friction |
|---|---|---|
| Drag-reducing Composition and | Friction | Reduction after |
| Dosage in 7% KCl brine | Reduction (%) | 10 minutes (%) |
| Anionic Dispersion Polymer 0.5 gpt | 72.7 | 52.3 |
| Example 4 (0.83 gpt) | 72.4 | 49.5 |
| Example 5 (0.83 gpt) | 71.5 | 48.4 |
| Example 6 (0.83 gpt) | 70.6 | 46.9 |

As shown in Table 4 and in FIG. 1, when surfactant and solvent are added to an anionic dispersion polymer to make a drag-reducing additive, the friction reduction performance of the drag-reducing additive is not significantly affected with respect to maximum friction reduction or friction reduction after 10 minutes. By using any of the drag-reducing additives described in Examples 4, 5, and 6 to form drag-reducing compositions, the friction reduction (sometimes known as drag reduction) benefits provided by the anionic dispersion polymer are preserved, while simultaneously achieving the benefits of solvents and surfactants when the drag-reducing composition is used in well treatment applications.

### Example 7

In a 140 ml jar, 5 g of ethoxylated castor oil surfactant and 15 g of d-limonene were mixed together. The mixture was stirred with a cage stirrer mixer at 735 rpm for about 15 s and then 30 g of a amphoteric dispersion polymer (polymer actives 20%) was added into stirred mixture. This composition comprises 10% ethoxylated castor oil surfactant, 30% d-limonene solvent, and 60% of the amphoteric dispersion polymer. Stirring continued for about 5 minutes. A homogeneous opaque mixture was obtained. The friction reduction performance of the mixture was evaluated in a friction flow loop in 7% KCl brine at a dose of 1.04 gallons per 1000 gallons (gpt) of brine at a flow rate of 10 gal/min.

TABLE 5
Drag reduction performance at equal polymer concentration
of compositions comprising drag-reducing additive
of Example 7 in 7% KCl brine

| | Maximum | % Friction |
|---|---|---|
| Drag-reducing Composition | Friction | Reduction after |
| and Dosage in 7% KCl brine | Reduction (%) | 10 minutes (%) |
| Amphoteric Dispersion Polymer | 77.4 | 52.9 |
| 0.625 gpt | | |
| Example 7 1.04 gpt | 77.0 | 51.0 |

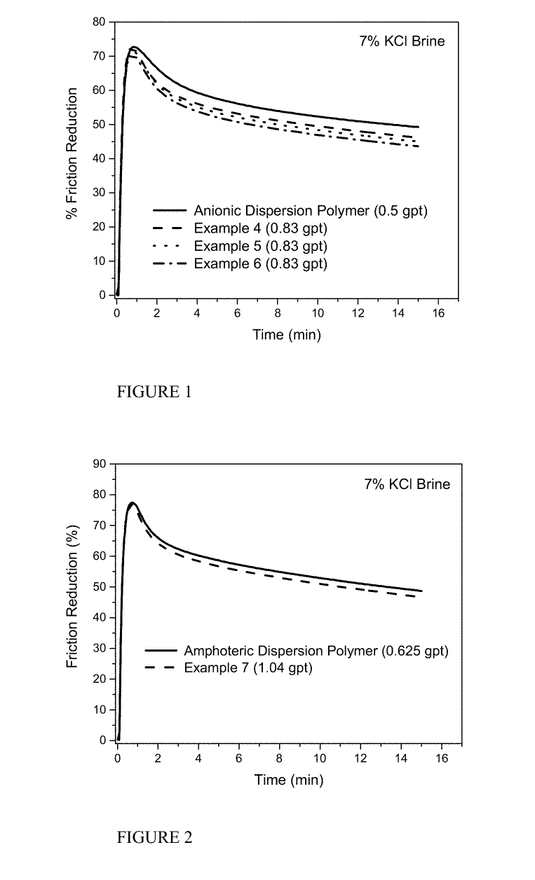

As shown in Table 5 and in FIG. 2, when surfactant and solvent are added to an amphoteric dispersion polymer to make a drag-reducing additive, the friction reduction performance of the dispersion polymer is not significantly affected with respect to maximum friction reduction or friction reduction after 10 minutes. By using the drag-reducing additive of Example 7 to form a drag-reducing composition, one would preserve friction reduction benefits of the amphoteric dispersion polymer, while simultaneously getting the benefits of solvents and surfactants when the composition is used in well treatment applications.

### Example 8

In a 140 ml jar, 5 g of ethoxylated castor oil surfactant and 15 g of d-limonene were mixed together. The mixture was stirred with a cage stirrer mixer at 735 rpm for about 15 s and then 30 g of cationic dispersion polymer (polymer actives 20%) was added into stirred mixture. Stirring continued for about 5 minutes. This composition comprises 10% ethoxylated castor oil surfactant, 30% d-limonene solvent, and 60% of the cationic dispersion polymer. The mixture separated into 2 layers on standing. The friction reduction performance of the mixture was evaluated in a friction flow loop in 7% KCl brine at a dose of 1.04 gallons per 1000 gallons (gpt) of brine at a flow rate of 10 gal/min.

### Example 9

In a 140 ml jar, 10 g of ethoxylated castor oil surfactant and 10 g of d-limonene solvent were mixed together. The mixture was stirred with a cage stirrer mixer at 735 rpm for about 15 s and then 30 g of cationic dispersion polymer (polymer actives 20%) was added into the stirred mixture. This composition comprises 20% ethoxylated castor oil surfactant, 20% d-limonene solvent, and 60% of the cationic dispersion polymer. Stirring continued for about 5 minutes. The mixture separated into 2 layers on standing. The friction reduction performance of the mixture was evaluated in a friction flow loop in 7% KCl brine at a dose of 1.04 gallons per 1000 gallons (gpt) of brine at a flow rate of 10 gal/min.

TABLE 6
Friction Reduction Performance of Compositions
Comprising Drag-reducing Additives of Examples
8-9 in 7% KCl brine at equal polymer loading

| | Maximum | % Friction |
|---|---|---|
| Drag-reducing Compositions | Friction | Reduction after |
| and Dosage in 7% KCl | Reduction (%) | 10 minutes (%) |
| Cationic Dispersion Polymer | 77.3 | 57.3 |
| 0.625 gpt | | |
| Example 8 1.04 gpt | 77.2 | 55.3 |
| Example 9 1.04 gpt | 77.2 | 54.4 |

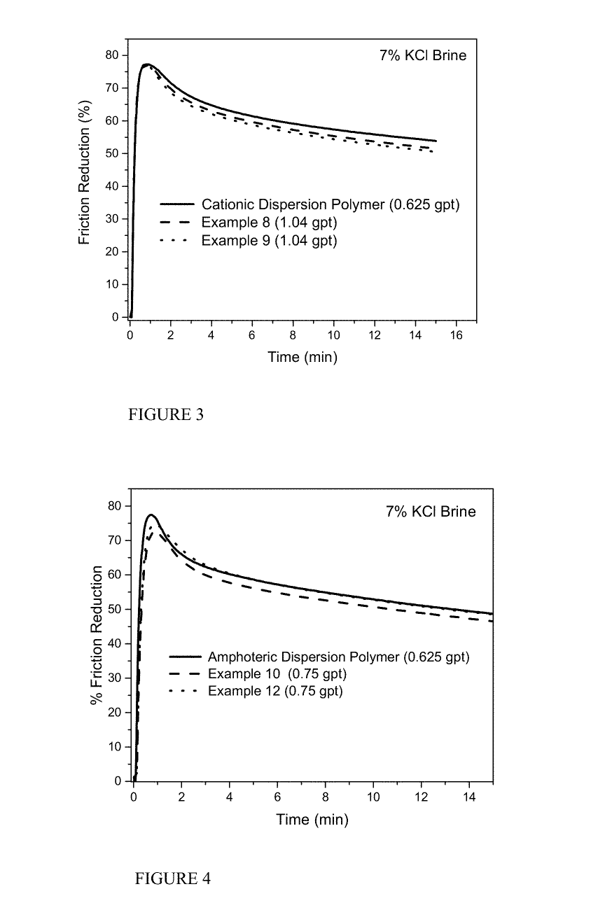

As shown in Table 6 and in FIG. 3, when surfactant and solvent are added to a cationic dispersion polymer to make a drag-reducing additive, the friction reduction performance of the dispersion polymer is not significantly affected with respect to maximum friction reduction or friction reduction after 10 minutes. By using the drag-reducing additive of Example 8-9 to form drag-reducing compositions, one would preserve friction reduction benefits of the amphoteric dispersion polymer, while simultaneously getting the benefits of solvents and surfactants when the composition is used in well treatment applications.

Microemulsions 1, 2, and 3 were used to prepare the drag-reducing additives described in Examples 10 to 15.

Microemulsion 1 comprises 20% to 70% alkylpolyglucoside surfactant, 5% to 25% of a polyamine alkoxylate surfactant, 5% to 25% of an ester-based solvent, 5% to 25% of a terpene solvent, 5% to 25% propylene glycol, 5% to 25% water, and 0.1% to 5% of acetic acid.

Microemulsion 2 comprises 5% to 30% of an ethoxylated alcohol surfactant having C₁₂-C₁₅ hydrocarbon chain and ethoxylated with 9 moles of ethylene oxide per mole of surfactant, 0.1% to 10% of ethoxylated castor oil surfactant having 40 moles of ethylene oxide per mole of surfactant, 5% to 40% of dipropylene glycol monomethyl ether, 5% to 40% propylene glycol, 5% to 40% non-oxygenated terpene solvent, and 5% to 40% of an oxygenated terpene solvent.

Microemulsion 3 comprises 23% of C₁₂-C₁₅ ethoxylated alcohol ethoxylated with 7 moles of ethylene oxide (commonly known as 25-7), 23% of isopropanol, 39% of water, and 15% of d-limonene.

### Example 10

In a 250 ml jar, 75 g of an amphoteric dispersion polymer and 15 g of Microemulsion 1 were mixed together. The mixture was stirred for 5 minutes with a cage stirrer mixer operated at 735 rpm. A homogeneous flowable drag-reducing additive was obtained.

### Example 11

In a 250 ml jar, 75 g of an amphoteric dispersion polymer and 15 g of Microemulsion 2 were mixed together. The mixture was stirred for 5 minutes with a cage stirrer mixer operated at 735 rpm. A homogeneous flowable drag-reducing additive was obtained.

### Example 12

In a 250 ml jar, 75 g of an amphoteric dispersion polymer and 15 g of Microemulsion 3 were mixed together. The mixture was stirred for 5 minutes with a cage stirrer mixer operated at 735 rpm. A homogeneous flowable drag-reducing additive was obtained.

### Example 13

In a 250 ml jar, 93 g of an anionic dispersion polymer and 7 g of Microemulsion 1 were mixed together. The mixture was stirred for 5 minutes with a cage stirrer mixer operated at 735 rpm. A homogeneous flowable drag-reducing additive was obtained

### Example 14

In a 140 ml jar, 49 g of an anionic dispersion polymer and 1 g of Microemulsion 3 were mixed together. The mixture was stirred for 5 minutes with a cage stirrer mixer operated at 735 rpm. A homogeneous flowable drag-reducing additive was obtained. This composition appeared to be thicker than the composition of Example 13.

### Example 15

In a 250 ml jar, 92 g of a cationic dispersion polymer and 8 g of Microemulsion 3 were mixed together. The mixture was stirred for 5 minutes with a cage stirrer mixer operated at 735 rpm. A homogeneous flowable drag-reducing additive was obtained.

TABLE 7
Friction Reduction Performance of Compositions Comprising
Drag-reducing Additives of Examples 10 and 12-15 in
7% KCl brine. Polymer loading is equivalent to that
in the corresponding dispersion polymer.

| | Maximum | % Friction |
|---|---|---|
| Drag-reducing Additives | Friction | Reduction after |
| and Dosage | Reduction (%) | 10 minutes (%) |
| Amphoteric Dispersion Polymer | 77.4 | 52.9 |
| 0.625 gpt | | |
| Example 10 0.75 gpt | 72.4 | 50.7 |
| Example 12 0.75 gpt | 74.7 | 52.7 |
| Anionic Dispersion Polymer | 72.7 | 52.3 |
| 0.5 gpt | | |
| Example 13 0.60 gpt | 67.8 | 53.8 |
| Example 14 0.51 gpt | 64.4 | 52.9 |
| Cationic Dispersion Polymer | 77.3 | 57.3 |
| 0.625 gpt | | |
| Example 15 0.68 gpt | 77.8 | 56.1 |

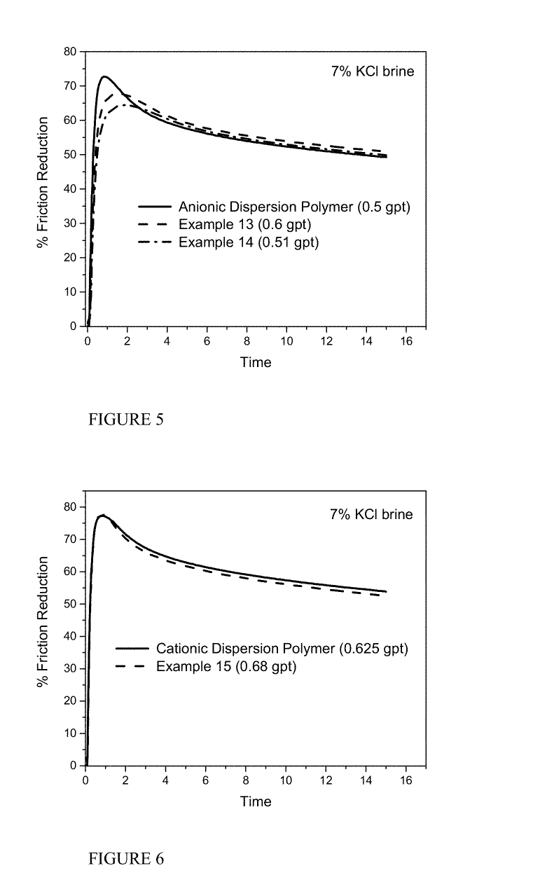

As shown in Table 7 and FIGS. 4-6, the addition of a microemulsion to a dispersion polymer results in drag-reducing compositions that allow one to achieve at least 64% of maximum friction reduction and at least 50% of residual friction reduction after 10 minutes.

### Visual Vial Experiments

The uniqueness of the present invention can also be demonstrated by carrying out a visual experiment. In this experiment, a series of drag-reducing additives were prepared and placed into Vials labeled 0, 1, 2, 3, and 4. The composition of each vial is set forth in Table 8.

TABLE 8
Compositions of samples used in visual vial experiments

| Vial | Sample Description |
|---|---|
| 0 | anionic dispersion polymer, 10 mol % anionic charge, |
| | very high molecular weight - no additives |
| 1 | 6.1 g anionic dispersion polymer + 0.54 g of castor |
| | oil ethoxylate surfactant |
| 2 | 6.0 g anionic dispersion polymer + 3.5 g d-limonene |
| | solvent |
| 3 | 6.1 g anionic dispersion polymer + 0.51 g of castor |
| | oil ethoxylate surfactant + 3.5 g d-limonene solvent |
| 4 | 6.1 g anionic dispersion polymer + 0.3 g Microemulsion 3 |

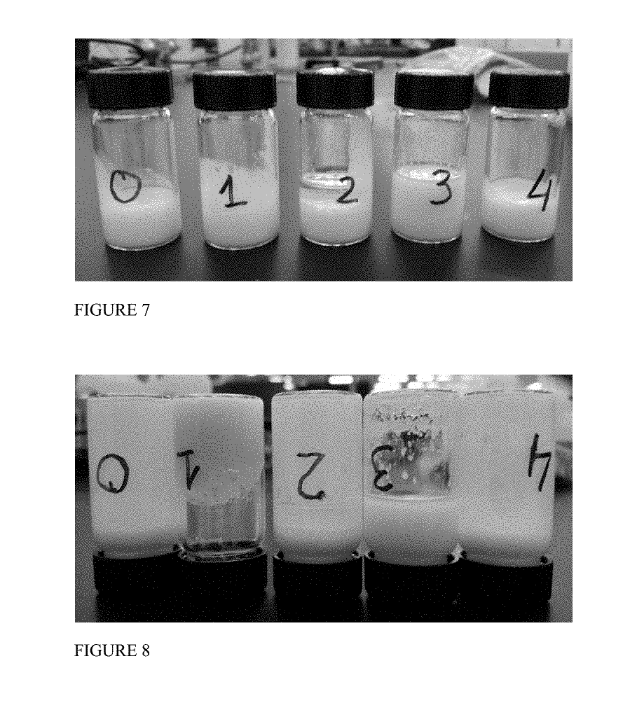

FIG. 7 is a photograph showing the compositions of Vials 0-4 immediately after mixing the ingredients set forth in Table 8. The results shown in FIG. 7 indicate that d-limonene solvent did not mix with the anionic dispersion polymer. After blending, the solvent has nearly instantly separated from the dispersion polymer (Vial 2). Samples shown in FIG. 7 were further vigorously shaken and the vials were each turned upside down and allowed to stand for 1 hour prior to taking a photograph. FIG. 8, which is a photograph of the inverted vials, indicate that the original dispersion polymer (Vial 0), dispersion polymer with added solvent and surfactant (Vial 3), and dispersion polymer with added microemulsion (Vial 4) all flowed from to the bottom of the vial as homogeneous mixtures without much separation. The mixture containing a blend of dispersion polymer and castor oil ethoxylate surfactant (Vial 1) formed a sticky, highly viscous paste (e.g., gunk) that did not readily flow. The mixture of dispersion polymer and d-limonene remained phase separated into two layers, as shown in FIG. 7. This result shows that one needs to combine both a surfactant and a solvent or a microemulsion with the dispersion polymer, in order to maintain the flow-ability of an essentially homogeneous composition that may be effectively pumped or injected downhole in an oil and/or gas well. Since dispersion polymers are designed not to contain any solvents, surfactants, microemulsions, or combinations thereof, their compatibility with these additives are not immediately evident from prior art.

It is clear that the present invention is well adapted to carry out its objectives and attain the ends and advantages mentioned above as well as those inherent therein. While presently preferred embodiments of the invention have been described in varying detail for purposes of disclosure, it will be understood that numerous changes may be made which will readily suggest themselves to those skilled in the art and which are encompassed within the spirit of the invention disclosed and claimed herein.

It is claimed:

1. A drag-reducing additive comprising:
a dispersion polymer; and
a microemulsion.

2. The drag-reducing additive of claim 1, wherein the dispersion polymer comprises:
a polymer; and
a saline solution.

3. The drag-reducing additive of claim 1, wherein the dispersion polymer is selected from the group consisting of amphoteric dispersion polymers, zwitterionic dispersion polymers, anionic dispersion polymers, and cationic dispersion polymers.

4. The drag-reducing additive of claim 1, wherein the microemulsion comprises:
a solvent;
a surfactant; and
an aqueous phase.

5. The drag-reducing additive of claim 4, wherein the solvent is a terpene solvent.

6. The drag-reducing additive of claim 4, wherein the surfactant is an alkylpolyglucoside surfactant.

7. The drag-reducing additive of claim 4, wherein the surfactant is an ethoxylated alcohol surfactant.

8. The drag-reducing additive of claim 1, wherein the dispersion polymer is present from about 70 wt % to about 99 wt % of the total weight of the drag-reducing additive.

9. The drag-reducing additive of claim 1, wherein the microemulsion is present from about 0.5 wt % to about 30 wt % of the total weight of the drag-reducing additive.

10. A drag-reducing composition comprising:
a drag-reducing additive, wherein the drag-reducing additive comprises:
a dispersion polymer; and
a microemulsion; and
an aqueous treatment fluid.

11. The drag-reducing composition of claim 10, wherein the drag-reducing composition comprises about 0.01 gallons to about 50 gallons of the drag-reducing additive per 1,000 gallons of the aqueous treatment fluid.

12. A method of using a drag-reducing composition comprising the steps of:
providing a drag-reducing additive comprising a dispersion polymer and a microemulsion;
forming the drag-reducing composition by combining the drag-reducing additive with an aqueous treatment fluid; and
injecting the drag-reducing composition into a subterranean formation, a pipeline or a gathering line.

13. The method of claim 12, wherein the step of forming the drag-reducing composition with the aqueous treatment fluid further comprises the step of adding the drag-reducing additive into the aqueous treatment fluid on-the-fly as the aqueous treatment fluid is injected into the subterranean formation, the pipeline or the gathering line.

14. The method of claim 12, wherein the step of forming the drag-reducing composition further comprises the step of adding the drag-reducing additive to the aqueous treatment fluid before the drag-reducing composition is injected into the subterranean formation, the pipeline or the gathering line.

15. The method of claim 12, wherein the step of forming the drag-reducing composition further comprises adding from about 0.01 gallons to about 50 gallons of the drag-reducing additive per 1,000 gallons of the aqueous treatment fluid.

16. The method of claim 12, wherein the dispersion polymer is an amphoteric dispersion polymer.

17. The method of claim 12, wherein the dispersion polymer is an anionic dispersion polymer.

18. The method of claim 12, wherein the dispersion polymer is a cationic dispersion polymer.

19. The method of claim 12, wherein the dispersion polymer is a zwitterionic dispersion polymer.

20. The method of claim 12, wherein the dispersion polymer is present from about 70 wt % to about 99 wt % of the total weight of the drag-reducing additive.

21. The method of claim 12, wherein the microemulsion is present from about 0.5 wt % to about 30 wt % of the total weight of the drag-reducing additive.

22. The method of claim 12, wherein the microemulsions comprises a solvent, a surfactant, and an aqueous phase.

23. The method of claim 22, wherein the solvent is a terpene solvent.

24. The method of claim 22, wherein the surfactant is an alkylpolyglucoside surfactant.

25. The method of claim 22, wherein the surfactant is an ethoxylated alcohol surfactant.
